(19) United States
(12) Patent Application Publication
(10) Pub. No.: US 2022/0107201 A1
(43) Pub. Date: Apr. 7, 2022

(54) DISPLAY CONTROL DEVICE AND NON-TRANSITORY COMPUTER-READABLE STORAGE MEDIUM

(71) Applicant: DENSO CORPORATION, Kariya-city (JP)

(72) Inventors: Akihiko YAGYU, Kariya-city (JP); Daisuke TAKEMORI, Kariya-city (JP); Yasuhiro SHIMIZU, Kariya-city (JP); Kazuki KOJIMA, Kariya-city (JP); Shiori MANEYAMA, Kariya-city (JP); Takeshi HATOH, Kariya-city (JP)

(21) Appl. No.: 17/644,115

(22) Filed: Dec. 14, 2021

Related U.S. Application Data
(63) Continuation of application No. PCT/JP2020/018863, filed on May 11, 2020.

(30) Foreign Application Priority Data
Jun. 27, 2019 (JP) 2019-120086
Jan. 6, 2020 (JP) 2020-000485

(51) Int. Cl. G01C 21/36; B60K 35/00

(52) U.S. Cl. CPC G01C 21/3658; G01C 21/3632; G01C 21/365; B60K 2370/191; B60K 2370/1529; B60K 2370/166; B60K 35/00

(57) ABSTRACT

A display for a vehicle is controlled, and route information of the vehicle is acquired. An acquired route content indicating a lane change trajectory is superimposed and displayed based on the route information on a road surface, and a route guidance content for executing the route guidance is superimposed and display in a position deviated from the lane change trajectory.

### CROSS REFERENCE TO RELATED APPLICATION

The present application is a continuation application of International Patent Application No. PCT/JP2020/018863 filed on May 11, 2020, which designated the U.S. and claims the benefit of priority from Japanese Patent Applications No. 2019-120086 filed on Jun. 27, 2019 and No. 2020-000485 filed on Jan. 6, 2020. The entire disclosures of all of the above applications are incorporated herein by reference.

### TECHNICAL FIELD

The present disclosure relates to a display control device and a non-transitory computer-readable storage medium.

### BACKGROUND

For example, a conceivable technique provides a vehicular display device providing guiding display for guiding a lane change using a head-up display.

It is supposed that guiding display including an arrow and the like in the conceivable technique can be made difficult for a driver to recognize due to, for example, a running position of a vehicle, a road configuration, or the like.

### SUMMARY

According to an example embodiment, a display for a vehicle is controlled, and route information of the vehicle is acquired. An acquired route content indicating a lane change trajectory is superimposed and displayed based on the route information on a road surface, and a route guidance content for executing the route guidance is superimposed and display in a position deviated from the lane change trajectory.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a drawing illustrating an overview of an onboard network including HCU according to a first embodiment of the present disclosure;

FIG. 2 is a drawing illustrating an example of a head-up display mounted in a vehicle;

FIG. 3 is a drawing schematically illustrating a configuration of HCU;

FIG. 4 is a drawing illustrating a visualized example of a simulation of a display layout performed at a display generation unit;

FIG. 5 is a drawing illustrating the details of route guidance display provided when a preceding car is not present at a branch point;

FIG. 6 is a drawing illustrating the details of route guidance display provided when a preceding car is present at a branch point;

FIG. 7 is a drawing illustrating the details of route guidance display provided at a merging point;

FIG. 8 is a flowchart illustrating the details of display control processing in the first embodiment;

FIG. 9 is a drawing schematically illustrating an example of a configuration of HCU in a second embodiment;

FIG. 10 is a drawing illustrating the details of route guidance display provided at a branch point;

FIG. 11 is a drawing illustrating the details of route guidance display provided at a merging point;

FIG. 12 is a flowchart illustrating the details of display control processing in conjunction with FIG. 13;

FIG. 13 is a flowchart illustrating the details of display control processing in conjunction with FIG. 12;

FIG. 14 is a drawing illustrating an example of route guidance display in Modification 1;

FIG. 15 is a drawing illustrating an example of route guidance display in Modification 2;

FIG. 16 is a drawing illustrating an example of route guidance display in Modification 3;

FIG. 17 is a drawing illustrating an example of route guidance display in Modification 6;

FIG. 18 is a drawing explaining route guidance display in a third embodiment;

FIG. 19 is a flowchart illustrating the details of display control processing in the third embodiment;

FIG. 20 is a drawing illustrating the details of route guidance display in a fourth embodiment;

FIG. 21 is a drawing illustrating the details of route guidance display in a fifth embodiment;

FIG. 22 is a drawing illustrating the details of route guidance display in a sixth embodiment;

FIG. 23 is a flowchart illustrating the details of display control processing in the sixth embodiment;

FIG. 24 is a drawing explaining an example of route guidance display in a seventh embodiment;

FIG. 25 is a drawing explaining another example of route guidance display in the seventh embodiment;

FIG. 26 is a drawing explaining further another example of route guidance display in the seventh embodiment;

FIG. 27 is a drawing explaining route guidance display at a scene where a rear vehicle does not follow a subject vehicle in an eighth embodiment;

FIG. 28 is a drawing explaining route guidance display at a scene where a rear vehicle is following a subject vehicle;

FIG. 29 is a drawing explaining an example of route guidance display in Modification 13;

FIG. 30 is a drawing illustrating an example of route guidance display in Modification 14;

FIG. 31 is a drawing illustrating the details of route guidance display in Modification 15;

FIG. 32 is a drawing illustrating the details of route guidance display in Modification 16;

FIG. 33 is a drawing illustrating the details of route guidance display in Modification 17 and the like;

FIG. 34 is a drawing illustrating the details of route guidance display in Modification 20;

FIG. 35 is a drawing illustrating the details of route guidance display in Modification 21;

FIG. 36 is a drawing illustrating the details of route guidance display in Modification 22;

FIG. 37 is a drawing illustrating the details of route guidance display in Modification 23;

FIG. 38 is a drawing illustrating the details of route guidance display in Modification 24;

FIG. 39 is a drawing illustrating an example of route guidance display in Modification 25;

FIG. 40 is a drawing illustrating an example of route guidance display in Modification 26;

FIG. 41 is a drawing illustrating the details of route guidance display in Modification 27;

FIG. 42 is a drawing illustrating the details of route guidance display in Modification 28; and

FIG. 43 is a drawing illustrating the details of route guidance display in Modification 29.

### DETAILED DESCRIPTION

A display control device and a display control program are provided to implement content display easy for a driver to recognize.

According to an example embodiment, a display control device used in a vehicle and controlling display provided by a head-up display includes: a route information acquisition unit acquiring route information of the vehicle; and a display control unit that superimposes and displays an acquired route content indicating a lane change trajectory based on the route information on a road surface and superimposes and displays a route guidance content providing route guidance in a position deviated from the lane change trajectory.

According to a an example embodiment, a display control program used in a vehicle and controlling display provided by a head-up display causes at least one processing unit to perform processing including: acquiring route information of the vehicle; superimposing and displaying an acquired route content indicating a lane change trajectory based on the route information on a road surface; and superimposing and displaying a route guidance content providing route guidance in a position deviated from the lane change trajectory.

In these example embodiments, not only an acquired route content indicating a lane change trajectory but also a route guidance content providing route guidance is superimposed and displayed in a position deviated from a lane change trajectory. Therefore, at a scene of making a movement according to route guidance, different timing of making a movement is permitted from driver to driver and at least any content can be presented at a time of making a movement. As a result, content display easy for a driver to recognize is implemented.

According to an example embodiment, a display control device used in a vehicle and controlling display provided by a head-up display includes: a positional information acquisition unit acquiring positional information of the vehicle; a route information acquisition unit acquiring route information of the vehicle in a guidance area where route guidance is to be provided; and a display control unit that, when route guidance is provided in the guidance area including a plurality of lanes, varies display control on a route guidance content used for route guidance according to a position of the subject vehicle's lane indicated by the positional information.

According to an example embodiment, a display control program used in a vehicle and controlling display provided by a head-up display causes at least one processing unit to perform processing including: acquiring route information of the vehicle in a guidance area where route guidance is to be provided; acquiring positional information of the vehicle; and, when route guidance is provided in the guidance area including a plurality of lanes, varying display control on a route guidance content used for route guidance according to a position of the subject vehicle's lane indicated by the positional information.

In these example embodiments, on a road including a plurality of lanes, display control on a route guidance content used for route guidance is varied according to a position of a subject vehicle's lane. When timing of displaying a route guidance content is appropriately controlled according to a position of a subject vehicle's lane, content display easy for a driver to recognize is implemented.

According to an example embodiment, a display control device used in a vehicle and controlling display provided by a head-up display includes: a positional information acquisition unit acquiring positional information of the vehicle; a route information acquisition unit acquiring route information of the vehicle in a guidance area where route guidance is to be provided; and a display control unit that provides route guidance in the guidance area using a route guidance content superimposed and displayed on a road surface, and increases or reduces a tone of the route guidance content as the vehicle approaches the guidance area based on the positional information.

According to an example embodiment, a display control program used in a vehicle and controlling display provided by a head-up display causes at least one processing unit to perform processing including: acquiring route information of the vehicle in a guidance area where route guidance is to be provided; providing route guidance in the guidance area using a route guidance content superimposed and displayed on a road surface; acquiring positional information of the vehicle; and increasing or reducing a tone of the route guidance content as the vehicle approaches the guidance area based on the positional information.

In these example embodiments, as a guidance area is approached, a tone of a route guidance content superimposed and displayed on a road surface is increased or reduced. According to the foregoing, a route guidance content not only provides route guidance but also can suggest whether obedience to route guidance is recommended or not by variation in tone. As a result, content display easy for a driver to recognize is implemented.

According to an example embodiment, a display control device used in a vehicle mounted with a guidance device providing route guidance using screen display and controlling display provided by a head-up display includes: a route information acquisition unit acquiring route information of the vehicle in a guidance area where route guidance is to be provided; a positional information acquisition unit acquiring positional information of the vehicle; and a display control unit providing route guidance in the guidance area using a route guidance content superimposed and displayed on the foreground. When the vehicle passes through the guidance area without obeying to route guidance, the display control unit terminates route guidance using the route guidance content before the guidance device terminates route guidance by the screen display.

According to an example embodiment, a display control program using in a vehicle mounted with a guidance device providing route guidance using screen display and controlling display provided by a head-up display causes at least one processing unit to perform processing including: acquiring route information of the vehicle in a guidance area where route guidance is to be provided; providing route guidance in the guidance area using a route guidance content superimposed and displayed on the foreground; acquiring positional information of the vehicle; and, when the vehicle passes through the guidance area without obeying to route guidance, terminating route guidance using the route guidance content before the guidance device terminates route guidance by the screen display.

In these example embodiments, route guidance using a route guidance content is terminated before a guidance device terminates route guidance by screen display. According to the foregoing, an event in which even when it is difficult to obey route guidance, route guidance by a route guidance content continues and a driver is confused can be avoided. Consequently, content display easy for a driver to recognize is implemented.

According to an example embodiment, a display control device used in a vehicle and controlling display provided by a head-up display includes: a route information acquisition unit acquiring route information of the vehicle in a guidance area where route guidance is to be provided; and a display control unit superimposing and displaying a route guidance content based on the route information on a road surface. When a different second branch point continues to a first branch point as the guidance area, in route guidance at the first branch point, the display control unit causes the route guidance content to be displayed with route guidance at the second branch point taken into account.

According to an example embodiment, a display control program used in a vehicle and controlling display provided by a head-up display causes at least one processing unit to perform processing including: acquiring route information of the vehicle in a guidance area where route guidance is to be provided; superimposing and displaying a route guidance content based on the route information on a road surface; and, when a different second branch point continues to a first branch point as the guidance area, displaying the route guidance content with route guidance at the second branch point taken into account in route guidance at the first branch point.

In these example embodiments, when a first branch point and a subsequent second branch point are continuous, a route guidance content providing route guidance at the first branch point is configured with route guidance at the second branch point taken into account. According to the foregoing, a route guidance content displayed at a first branch point can be matched with an image of a behavior a driver assumes in an attempt to make continuous branching. Therefore, content display easy for a driver to recognize is implemented.

### First Embodiment

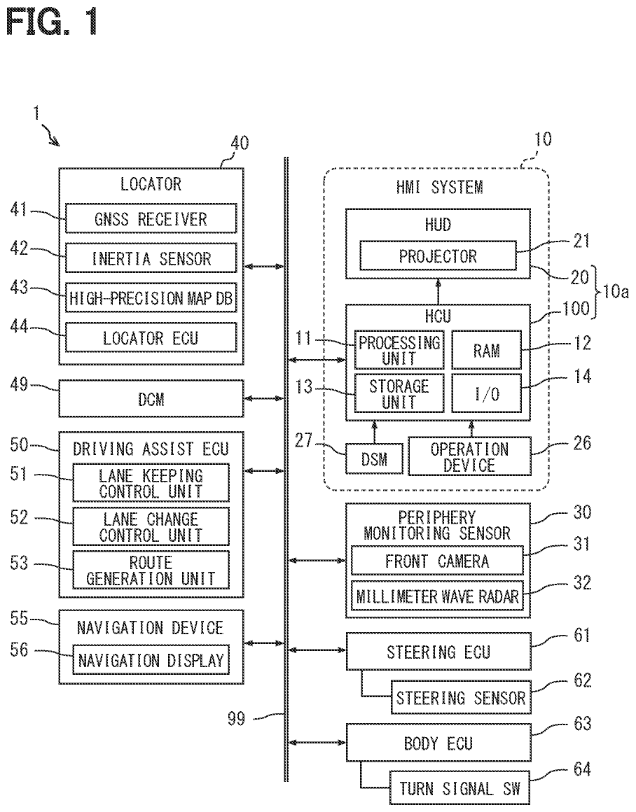

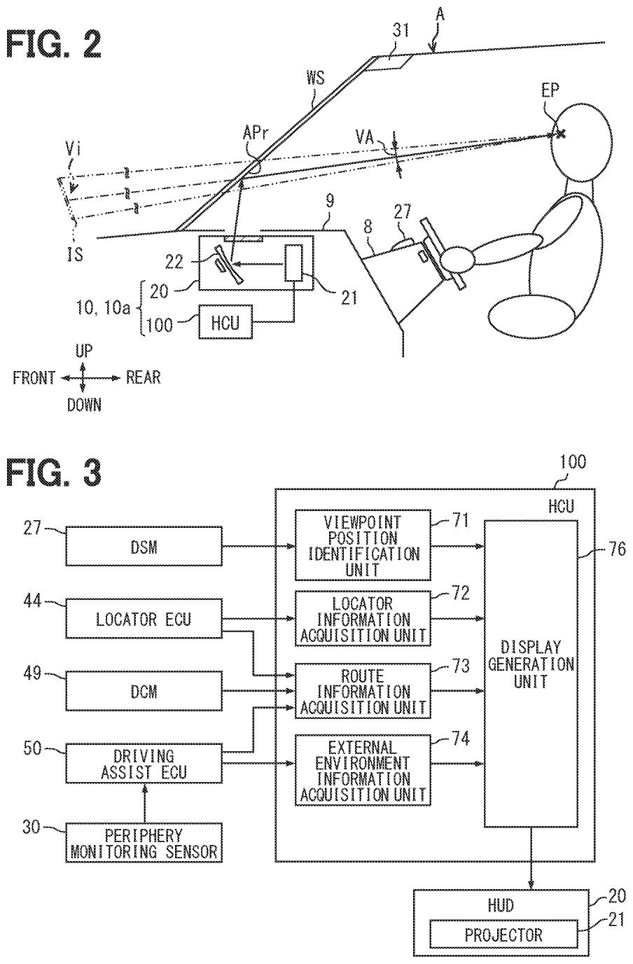

The functionality of a display control device according to the first embodiment of the present disclosure is implemented by HCU (Human Machine Interface Control Unit) 100 shown in FIG. 1 and FIG. 2. The HCU 100 constitutes an HMI (Human Machine Interface) system 10 used in a vehicle A together with a head-up display (hereafter referred to as “HUD”) 20 and the like. The HMI system 10 further includes an operation device 26, DSM (Driver Status Monitor) 27, and the like. The HMI system 10 has an input interface function of accepting a user operation by an occupant (for example, a driver or the like) of the vehicle A and an output interface function of presenting information to a driver.

The HMI system 10 is communicatively connected to a communication bus 99 of an onboard network 1 mounted in the vehicle A. The HMI system 10 is one of a plurality of nodes provided in the onboard network 1. The communication bus 99 of the onboard network 1 is connected with a periphery monitoring sensor 30, a locator 40, DCM 49, a driving assist ECU (Electronic Control Unit) 50, a navigation device 55, and the like as nodes. In addition, a steering ECU 61, a body ECU 63, and the like are connected to the communication bus 99. These nodes connected to the communication bus 99 are capable of communicating with one another.

In the following description, each direction, frontward, rearward, leftward, or rightward, is defined relative to the vehicle A at rest on a horizontal plane. Specifically, frontward and rearward directions are defined along the longitudinal direction of the vehicle A. Leftward and rightward directions are defined along the width direction of the vehicle A.

The periphery monitoring sensor 30 is an autonomous sensor monitoring the surrounding environment of the vehicle A. The periphery monitoring sensor 30 is capable of detecting any moving object such as a pedestrian, a cyclist, an animal other than humans, another vehicle, or the like as well as any stationary object such as a fallen object on the road, a guardrail, a curb, a road sign, a road surface marking such as a lane marking, a structure, or the like located on the roadside within a detection coverage of the subject vehicle. The periphery monitoring sensor 30 provides detection information obtained as the result of detection of an object on the periphery of the vehicle A to the driving assist ECU 50 and the like via the communication bus 99.

The periphery monitoring sensor 30 includes a front camera 31 and a millimeter wave radar 32 as detecting configuration elements for object detection. The front camera 31 outputs at least either of imaging data obtained by picking up an image of the frontward area of the vehicle A or a result of an analysis of the imaging data as detection information. The millimeter wave radar 32 is installed on, for example, each bumper at the front and rear of the vehicle A with a distance in between. The millimeter wave radar 32 irradiates the frontward area, front lateral side arear, rearward area, rear lateral side area, and the like of the vehicle A with a millimeter wave or a submillimeter wave. The millimeter wave radar 32 generates detection information by the processing of receiving a reflected wave reflected by a moving object a stationary object, or the like. Such a detecting configuration element as a lidar, a sonar, or the like may be included in the periphery monitoring sensor 30.

The locator 40 generates accurate positional information and the like of the vehicle A by complex positioning based on a combination of a plurality of pieces of acquired information. The locator 40 is configured to include a GNSS (Global Navigation Satellite System) receiver 41, an inertia sensor 42, a high-precision map database (hereafter, referred to as “high-precision map DB”) 43, and a locator ECU 44.

The GNSS receiver 41 receives positioning signals transmitted from a plurality of artificial satellites (positioning satellites). The GNSS receiver 41 is capable of receiving positioning signals from each positioning satellite of at least one satellite positioning system among satellite positioning systems including GPS, GLONASS, Galileo, IRNSS, QZSS, Beidou, and the like.

The inertia sensor 42 includes, for example, a gyro sensor and an acceleration sensor. The high-precision map DB 43 is configured based on non-volatile memory and stores more precise map data (hereafter, referred to as “high-precision map data”) than map data (hereafter, referred to as “navigation map data”) used in the navigation device 55 is. The high-precision map data caries detailed information about information at least in the height (z) direction. The high-precision map data includes information utilizable in sophisticated driving assistance and automatic operation, such as three-dimensional shape information of roads, number-of-lanes information, information indicating a traveling direction permitted in each lane, and the like. The high-precision map data further includes information of node points indicating the positions of both ends of such a road marking as a white line, for example.

The locator ECU 44 is configured based on a microcomputer including a processor, RAM, a storage unit, an input/output interface, a bus connecting these elements, and the like. The locator ECU 44 combines a positioning signal received at the GNSS receiver 41, a result of measurement at the inertia sensor 42, vehicle speed information outputted to the communication bus 99 and the like to successively determine a subject vehicle position, a traveling direction, and the like of the vehicle A. The locator ECU 44 is capable of providing positional information and bearing information of the vehicle A based on a result of positioning to the navigation device 55, the HCU 100, the driving assist ECU 50, and the like as locator information. In addition, the locator ECU 44 is capable of providing requested high-precision map data to a requesting ECU in response to a request from the HCU 100, the driving assist ECU 50, or the like.

The DCM (Data Communication Module) 49 is a communication module mounted in the vehicle A. The DCM 49 transmits and receives radio waves between the DCM and a base station in the vicinity of the vehicle A via wireless communication conforming to such a communication standard as LTE (Long Term Evolution), 5G, or the like. Installation of the DCM 49 makes the vehicle A connected car connectable to the Internet. The DCM 49 can receive the newest high-precision map data from a server provided in the cloud. The DCM 49 updates high-precision map data stored in the high-precision map DB 43 to the newest information in cooperation with the locator ECU 44.

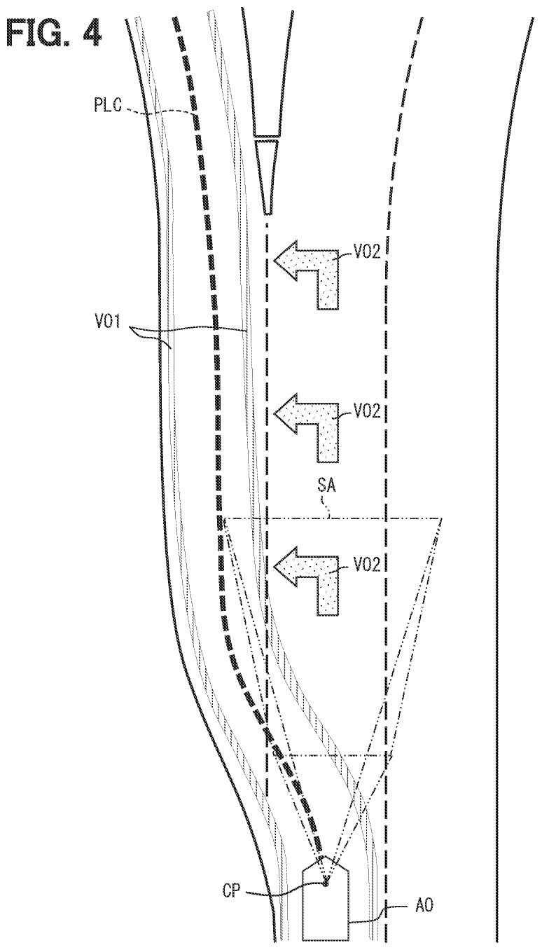

The DCM 49 may be capable of communicating with a server (hereafter, referred to as “route generation server”) generating a running path of the vehicle A. The route generation server generates a recommended running line equivalent to a lane change trajectory PLC (Refer to FIG. 4) described below about a branch point to a highway exit or the like, a merging point to a main lane, or the like. The route generation server grasps a traffic situation or the like at, for example, a branch point or a merging point and generates a recommended running line. When a recommended running line is received from the route generation server, the DCM 49 provides information defining a shape of the recommended line to the HCU 100 as route information.

The driving assist ECU 50 is configured based on a computer including a processor, RAM, a storage unit, an input/output interface, a bus connecting these elements, and the like. The driving assist ECU 50 has a driving assistance function assisting a driver's driving operation or an automatic operation function that can be replaced with a driver's driving operation. For example, the driving assist ECU 50 enables sophisticated driving assistance or partial automatic running control at level 2 to 3 or so according to the automatic operation level prescribed by the Society of Automotive Engineers.

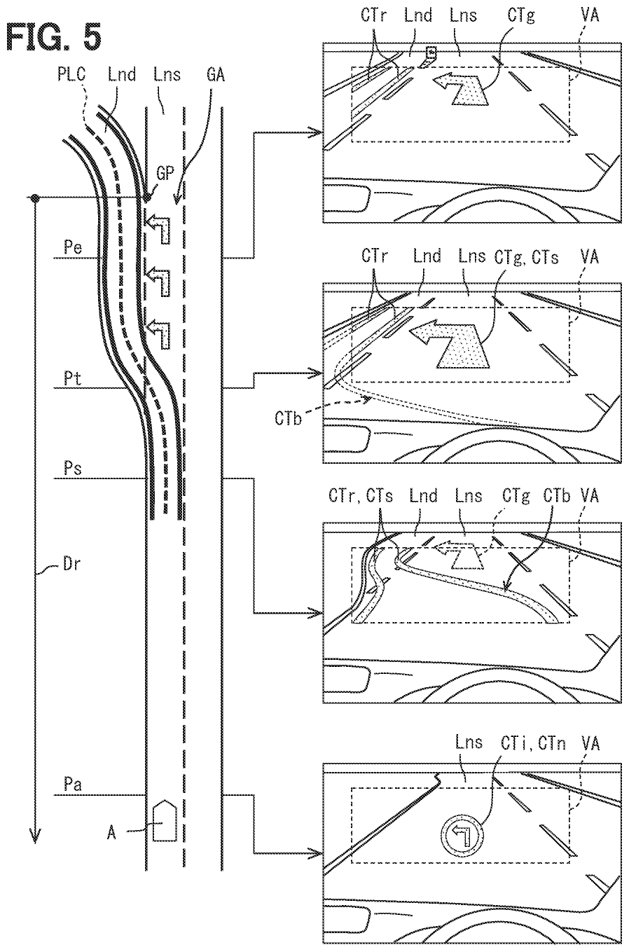

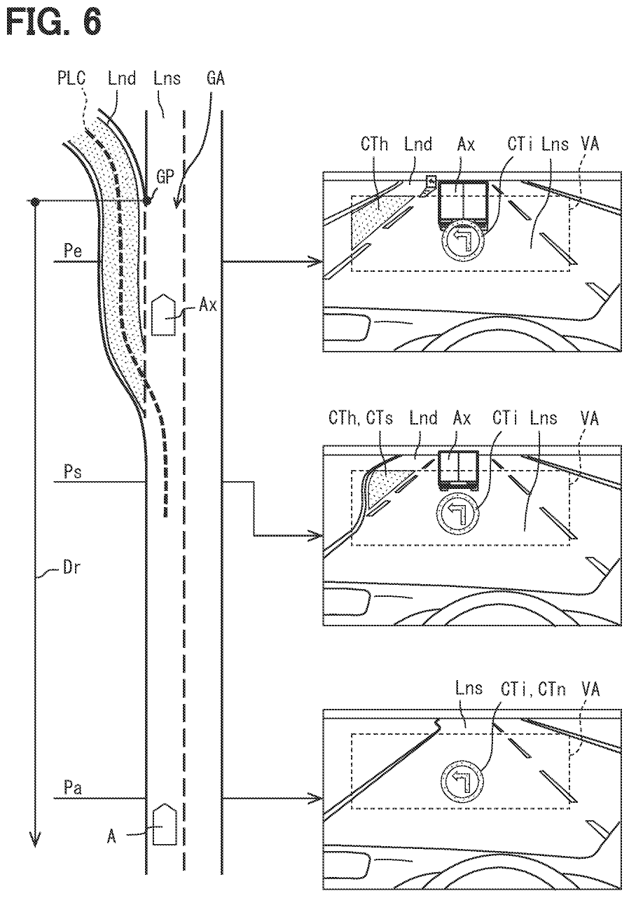

The driving assist ECU 50 recognizes a running environment around the vehicle A for driving control described later based on detection information acquired from the periphery monitoring sensor 30. For example, on a road including a plurality of lanes, the driving assist ECU 50 identifies a lane (hereafter, referred to as “subject vehicle's lane Lns”; Refer to FIG. 5) in which the vehicle A is presently running from among the above lanes. A more detailed description will be given. The driving assist ECU 50 recognizes the left and right division lines of the subject vehicle's lane Lns or a shape of a road end and compares a recognized boundary shape with a shape of division lines entered into the high-precision map data based on locator information. By such matching processing, the driving assist ECU 50 generates information (hereafter, referred to as “lane-specific information”) indicating a position of the subject vehicle's lane Lns and provides the information to the HCU 100. In addition, the driving assist ECU 50 recognizes a preceding car Ax (Refer to FIG. 6) running ahead of the subject vehicle and provides information (hereafter, referred to as “preceding car information”) indicating a shape, a size, a relative position, and the like of the preceding car Ax to the HCU 100.

The driving assist ECU 50 includes a plurality of functional units that implement automatic operation or driving assistance by execution of a program by a processor. Specifically, the driving assist ECU 50 includes an ACC (Adaptive Cruise Control) control unit, a lane keeping control unit 51, a lane change control unit 52, and a route generation unit 53. The ACC control unit is a functional unit implementing the functionality of ACC that causes the vehicle A to run at a constant speed of a target vehicle speed or the vehicle A to make a following run with a following distance maintained between the vehicle A and the preceding car.

The lane keeping control unit 51 is a functional unit implementing the functionality of LTC (Lane Trace Control) that controls running of the vehicle A within a lane. The lane keeping control unit 51 controls a steering angle of a steering wheel of the vehicle A based on recognition information of division lines and the like extracted from imaging data of the front camera 31 or the like. The lane keeping control unit 51 exercises driving control of causing the vehicle A to continuously make a run (hereafter, referred to as “in-lane running”) along the subject vehicle's lane Lns in cooperation with the ACC control unit.

The lane change control unit 52 is a functional unit implementing the functionality of LCA (Lane Change Assist) that controls a lane change by the vehicle A. The lane change control unit 52 temporarily stops driving control of in-lane running by the lane keeping control unit 51 to allow a departure from the subject vehicle's lane Lns based on a driver operation instructing execution of LCA. In this situation, the lane change control unit 52 automatically controls a steering angle of a steering wheel of the vehicle A to move the vehicle A from the subject vehicle's lane Lns to an adjacent lane Lnd (Refer to FIG. 5).

The route generation unit 53 appropriately combines locator information, high-precision map data, detection information, and the like to generate a planned running path used in the LTC function and the LCA function. When in-lane running by the lane keeping control unit 51 is in progress, the route generation unit 53 generates a planned running path in such a shape as to follow the center of the subject vehicle's lane Lns (Refer to FIG. 5). In addition, when an automatic lane change is made by the lane change control unit 52, the route generation unit 53 generates a planned running path in such a shape as to smoothly connect the center of the subject vehicle's lane Lns and the center of an adjacent lane Lnd.

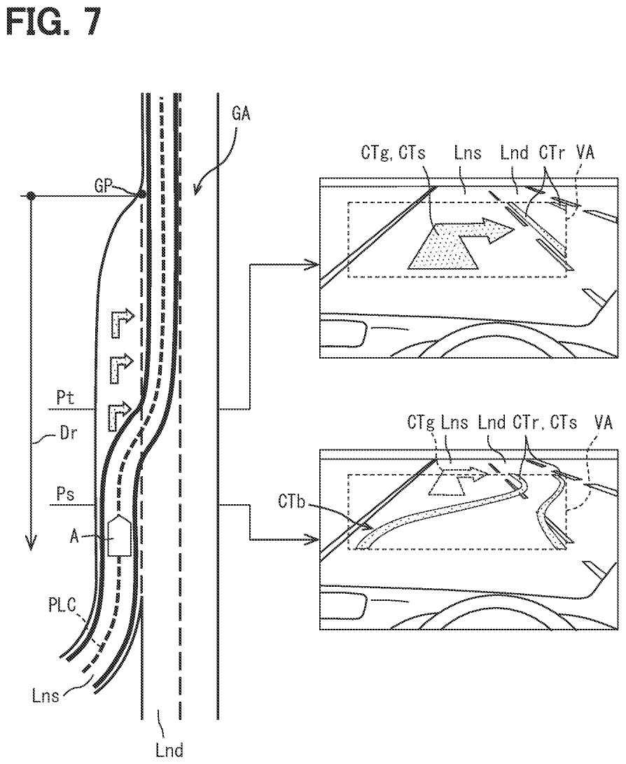

In addition, when route guidance is being provided by the navigation device 55, the route generation unit 53 generates an ideal running path. The route generation unit 53 can generate an ideal running path regardless of operating states of the LTC function and the LCA function. Ideal running path refers to a running path in which the vehicle A can be made to run according to route guidance with the lowest risk on the precondition of a road shape based on high-precision map data. The route generation unit 53 generates an ideal running path for a lane change from the subject vehicle's lane Lns to an adjacent lane Lnd as a destination of movement at a branch point (Refer to FIG. 5) where the vehicle A departs from a main lane, a merging point (Refer to FIG. 7) where the vehicle A meets a main lane, or the like. The route generation unit 53 can output information defining a shape of an ideal running path (lane change trajectory PLC; Refer to FIG. 4) for a lane change toward the HCU 100 as route information of the vehicle A.

A data format of route information may be appropriately changed as long as a shape of a running path is restorable at the HCU 100. In an example, route information is configured in a data format in which three-dimensional coordinate information of a plurality of specific points on a lane change trajectory PLC and information of a length, a curvature radius, and the like of an imaginary line connecting individual specific points are included. In another example, route information is configured in a data format in which three-dimensional coordinate information of a large number of points lined on a lane change trajectory PLC at predetermined intervals is included.

Further, in place of the driving assist ECU 50, the locator ECU 44 may have a function of generating a lane change trajectory PLC based on high-precision map data may be provided. In such a configuration, the locator ECU 44 provides route information indicating a generated lane change trajectory PLC to the HCU 100 and the like together with high-precision map data.

The navigation device 55 is an onboard device that provides route guidance to a destination set by a driver or the like in cooperation with the HMI system 10. The navigation device 55 acquires operation information inputted to the operation device 26 and establishes a destination based on a user operation and a route to that destination. The navigation device 55 provides a guide for going straight, a left or right turn, a lane change, or the like at in such a guidance area GA (Refer to FIG. 5 and the like) as an intersection, a branch point, a merging point, or the like included in an established route via screen display on a navigation display 56, a reproduced voice, or the like.

In place of the navigation device 55, such a user terminal as a smartphone may be connected to the onboard network 1 or the HCU 100. In an application executed at the user terminal, a route to a destination is set based on a user operation by a driver or the like. Like the navigation device 55, the user terminal provides guidance for driving operation at an intersection, a branch point, and the like via screen display and voice.

The steering ECU 61 is ECU provided in a steering control system of the vehicle A and is configured based on a microcontroller. The steering ECU 61 controls operation of a steering actuator based on at least one of a steering operation by a driver and a control command acquired by the driving assist ECU 50 and thereby defines an orientation of a steering wheel and by extension a traveling direction of the vehicle A. The steering ECU 61 is capable of providing a direction and an angle (steering wheel angle) of rotation of a steering wheel detected with a steering sensor 62 to the driving assist ECU 50, the HCU 100, and the like as steering information. The steering information may be a steering direction and an actual steering angle of a steering wheel.

The body ECU 63 is a control device mainly including a microcontroller. The body ECU 63 has at least a function of controlling operation of lighting devices mounted in the vehicle A. The body ECU 63 is electrically connected to a turn signal switch 64. The turn signal switch 64 is a lever-like operation part provided in a steering column portion 8. The body ECU 63 starts flashing of a left or right turn signal lamp corresponding to an operation direction based on detection of a user operation inputted to the turn signal switch 64.

In addition to an ordinary user operation for starting flashing operation of a turn signal lamp, a turn-on operation instructing the lane change control unit 52 to exercise lane change control with the LTC function active is inputted to the turn signal switch 64. In an example, a user operation of pressing the turn signal switch 64 halfway down for a predetermined time (for example, 1 to 3 seconds or so) is taken as a turn-on operation for the LCA function. In response to detection of an input of a turn-on operation for the LCA function, the body ECU 63 outputs turn-on operation information toward the driving assist ECU 50. While an automatic lane change is being made by the LCA function, The body ECU 63 causes flashing of a turn signal lamp to be continued in cooperation with the driving assist ECU 50. The body ECU 63 provides operating information indicating an operating state of flashing of a turn signal lamp to the HCU 100 via the communication bus 99.

A detailed description will be sequentially given to each of the operation device 26, DSM 27, HUD 20, and HCU 100 included in the HMI system 10.

The operation device 26 is an input unit accepting a user operation by a driver or the like. The operation device 26 accepts an input of a user operation switching between start and stop with respect to, for example, a driving assistance function, an automatic operation function, and the like. Specifically, the operation device 26 includes a steering switch provided in a spoke of a steering wheel, an operation lever provided in a steering column portion 8, a voice input device detecting a driver's speech, and the like.

The DSM 27 is configured to include a near-infrared light source and a near-infrared camera and a control unit controlling these elements. The DSM 27 is installed on, for example, the upper face of the steering column portion 8 or the upper face of an instrument panel 9 with the near-infrared camera facing to a headrest portion of a driver's seat. The DSM 27 picks up an image of the head of a driver irradiated with near-infrared light from the near-infrared light source with the near-infrared camera. An image picked up by the near-infrared camera is analyzed by the control unit. The control unit extracts such information as a position of an eye point EP, a sight direction, and the like from a picked-up image and successively outputs the extracted status information toward the HCU 100.

The HUD 20 is mounted in the vehicle A as one of a plurality of onboard display devices together with a meter display, the navigation display 56, and the like. The HUD 20 is electrically connected with the HCU 100 and successively acquires picture data generated by the HCU 100. Based on picture data, the HUD 20 presents varied information related to the vehicle A, such as route information, sign information, status information of each onboard function, and the like, to a driver using a virtual image Vi.

The HUD 20 is housed in a housing space inside the instrument panel 9 below a windshield WS. The HUD 20 projects light formed into a virtual image Vi toward a projection range APr of the windshield WS. The light projected to the windshield WS is reflected to the driver's seat side at the projection range APr and is perceived by a driver. The driver visually recognizes a display with the virtual image Vi superimposed on the foreground seen through the projection range Apr.

The HUD 20 includes a projector 21 and a magnification optical system 22. The projector 21 includes an LCD (Liquid Crystal Display) panel and a backlight. The projector 21 is fixed in a casing of the HUD 20 with a display surface of the LCD panel facing toward the magnification optical system 22. The projector 21 displays each frame image of picture data on the display surface of the LCD panel and illuminates the display surface by the backlight in a transmitted manner, and thereby ejects light formed into the virtual image Vi toward the magnification optical system 22. The magnification optical system 22 is configured to include at least one optical element such as a concave mirror. The magnification optical system 22 expands light ejected from the projector 21 by reflection and projects the light to the projection range APr located above.

In the above-mentioned HUD 20, a view angle VA is established. When a virtual area within a space where a virtual image Vi can be formed with the HUD 20 is taken as an image forming face IS, the view angle VA is an angular field of view defined based on an imaginary line connecting an eye point EP of a driver and the outer edge of an image forming face IS. The view angle VA is a range of angle within which a driver can visually recognize a virtual image Vi as viewed from an eye point EP. In the HUD 20, a horizontal view angle in the horizontal direction is larger than a vertical view angle in the vertical direction. A frontward area overlapping with an image forming face IS is an area within a view angle VA as viewed from an eye point EP.

The HUD 20 displays a superimposed content CTs (Refer to FIG. 5) and a non-superimposed content CTn (Refer to FIG. 5 and the like) as a virtual image Vi. A superimposed content CTs is an AR displayed item used in augmented reality (hereafter, referred to as “AR”) display. A display position of a superimposed content CTs is associated with a specific superimposed target present in the foreground, such as, for example, a specific position on a road surface, a vehicle ahead, a pedestrian, a road sign, and the like. A superimposed content CTs is superimposed and displayed on a specific superimposed target present in the foreground and can be moved following the superimposed target in a driver's view as if the superimposed content were relatively fixed on the superimposed target. That is, a relative positional relation between a driver's eye point EP, a superimposed target in the foreground, and a superimposed content CTs is continuously maintained. For this reason, a shape of a superimposed content CTs is continuously updated in a predetermined cycle in accordance with a relative position and a shape of a superimposed target. Superimposed contents CTs are displayed in a near-horizontal position as compared with non-superimposed contents CTn and are displayed, for example, in such a shape as to be extended in the depth direction as viewed from a driver.

A non-superimposed content CTn is a non-AR displayed item among displayed items superimposed and displayed in the foreground, excluding superimposed contents CTs. Unlike a superimposed content CTs, a non-superimposed content CTn is superimposed and displayed in the foreground without any specific superimposed target. A display position of a non-superimposed content CTn is not associated with a specific superimposed target. A display position of a non-superimposed content CTn is a predetermined position within a projection range APr (view angle VA). Therefore, a non-superimposed content CTn is displayed as if the non-superimposed content were relatively fixed on such a vehicle's configuration element as the windshield WS. In addition, a shape of a non-superimposed content CTn is substantially constant. Because of a positional relation between the vehicle A and a superimposition target, an occasion where even a non-superimposed content CTn is superimposed and displayed on a superimposition target of a superimposed content CTs may arise.

The HCU 100 is an electronic control device systematically controlling display by such onboard display devices as a meter display and the HUD 20 in the HMI system 10. The HCU 100, the HUD 20, and the like constitute a virtual image display system 10a. In the first embodiment, the processing functionality of the HCU 100 is installed in a control circuit provided in the meter device. The HCU 100 is configured based on a computer including a processing unit 11, RAM 12, a storage unit 13, an input/output interface 14, a bus connecting these elements, and the like.

The processing unit 11 is hardware for computing operation coupled with the RAM 12. The processing unit 11 is configured to include at least one computation core such as CPU (Central Processing Unit), GPU (Graphics Processing Unit), and the like. The processing unit 11 may be configured to further include FPGA (Field-Programmable Gate Array), an IP core, and the like having other dedicated functions. The RAM 12 may be configured to include a video RAM for generating pictures. The processing unit 11 performs varied processing for implementing a display control method of the present disclosure by accessing the RAM 12. The storage unit 13 is configured to include a nonvolatile storage medium. Various programs (display control program and the like) executed by the processing unit 11 are stored in the storage unit 13.

The HCU 100 shown in FIG. 1 to FIG. 3 includes a plurality of functional units for controlling superimposed display of contents by the HUD 20 by causing the processing unit 11 to execute a display control program stored in the storage unit 13. Specifically, such functional units as a viewpoint position identification unit 71, a locator information acquisition unit 72, a route information acquisition unit 73, an external environment information acquisition unit 74, a display generation unit 76, and the like are built in the HCU 100.

The viewpoint position identification unit 71 identifies a position of the eye point EP of a driver seated on a driver's seat based on status information acquired from the DSM 27. The viewpoint position identification unit 71 generates three-dimensional coordinates (hereafter, referred to as “eye point coordinates”) indicating a position of an eye point EP and successively provides the generated eye point coordinates to the display generation unit 76.

The locator information acquisition unit 72 acquires the newest locator information about the vehicle A from the locator ECU 44. The locator information acquisition unit 72 acquires high-precision map data of a peripheral area of the vehicle A from the locator ECU 44. The locator information acquisition unit 72 successively provides the acquired locator information and high-precision map data to the display generation unit 76.

For example, when route guidance to a destination is being provided by the navigation device 55 and the like, the route information acquisition unit 73 acquires route information of the vehicle A about the nearest guidance area GA from at least one of the driving assist ECU 50, the locator ECU 44, and the DCM 49. The route information acquisition unit 73 acquires route information defining a shape of a lane change trajectory PLC (Refer to FIG. 4) at least at the scene of approaching to a branch point or a merging point. When route information is acquired from more than one of the driving assist ECU 50, the locator ECU 44, and the DCM 49, the route information acquisition unit 73 selects one piece of route information according to predefined precedence.

The external environment information acquisition unit 74 acquires lane-specific information and preceding car information outputted to the communication bus 99 by the driving assist ECU 50. The external environment information acquisition unit 74 may acquire imaging data of the front camera 31 in place of these pieces of information as a result of analysis by the driving assist ECU 50. In this case, the external environment information acquisition unit 74 performs processing of extracting the lane-specific information and the preceding car information from the imaging data.

The display generation unit 76 controls information presentation to a driver by the HUD 20 by generating picture data successively outputted to the HUD 20. The display generation unit 76 renders an original image of each content displayed as a virtual image Vi in individual frame images constituting picture data. When an original image of a superimposed content CTs (Refer to FIG. 5 and the like) is rendered in a frame image, the display generation unit 76 corrects a rendering position and a rendering shape of the original image in the frame image according to respective positions of an eye point EP and a superimposition target. According to the foregoing, a superimposed content CTs is displayed in a position and a shape properly superimposed on a superimposition target as viewed from an eye point EP.

To implement the above-mentioned function of generating picture data, the display generation unit 76 further has a virtual layout function and a content selecting function. The virtual layout function is a function of simulating a display layout of a superimposed content CTs based on varied information provided to the display generation unit 76. When route information is acquired at the route information acquisition unit 73, the display generation unit 76 reproduces the present running environment of the vehicle A in a virtual space based on that route information, locator information, high-precision map data, lane-specific information, and the like.

A detailed description will be given. As shown in FIG. 2 to FIG. 4, the display generation unit 76 establishes a subject vehicle object AO in a reference position in a virtual three-dimensional space. The display generation unit 76 maps a road model in a shape indicating high-precision map data into the three-dimensional space in association with the subject vehicle object AO based on locator information and lane-specific information. The display generation unit 76 reproduces a lane change trajectory PLC in a shape based on route information on the road model.

In addition, the display generation unit 76 sets a virtual camera position CP and a superimposition area SA in association with the subject vehicle object AO. The virtual camera position CP is a virtual position corresponding to the eye point EP of a driver. The display generation unit 76 successively corrects a virtual camera position CP relative to the subject vehicle object AO based on the newest eye point coordinates acquired at the viewpoint position identification unit 71. The superimposition area SA is an area where superimposed display of a virtual image Vi is possible. The display generation unit 76 establishes a frontward area located inside an image forming face IS as viewed frontward from a virtual camera position CP as a superimposition area SA based on a virtual camera position CP and outer edge position (coordinates) information of the image forming face IS stored in the storage unit 13 (Refer to FIG. 1) and the like in advance. A superimposition area SA corresponds to a view angle VA of the HUD 20.

Further, the display generation unit 76 disposes a first virtual object VO1 and a second virtual object VO2 on a road surface of a road model in a three-dimensional space. The first virtual object VO1 is an object defining a shape of an ideal route content CTr (Refer to FIG. 5) described later. When an ideal route content CTr is displayed as a virtual image, the first virtual object VO1 is established in the virtual space. The second virtual object VO2 is an object defining a shape of a route guidance content CTg (Refer to FIG. 5) described later. When a route guidance content CTg is displayed as a virtual image, the second virtual object VO2 is established in the virtual space. A second virtual object VO2 is disposed in a position deviated from a first virtual object VO1 so as to avoid overlapping with the first virtual object VO1 on a road model. A shape of each virtual object VO1, VO2 within a superimposition area SA as viewed from a virtual camera position CP is a virtual image shape of each content CTr, CTg visually recognized from an eye point EP.

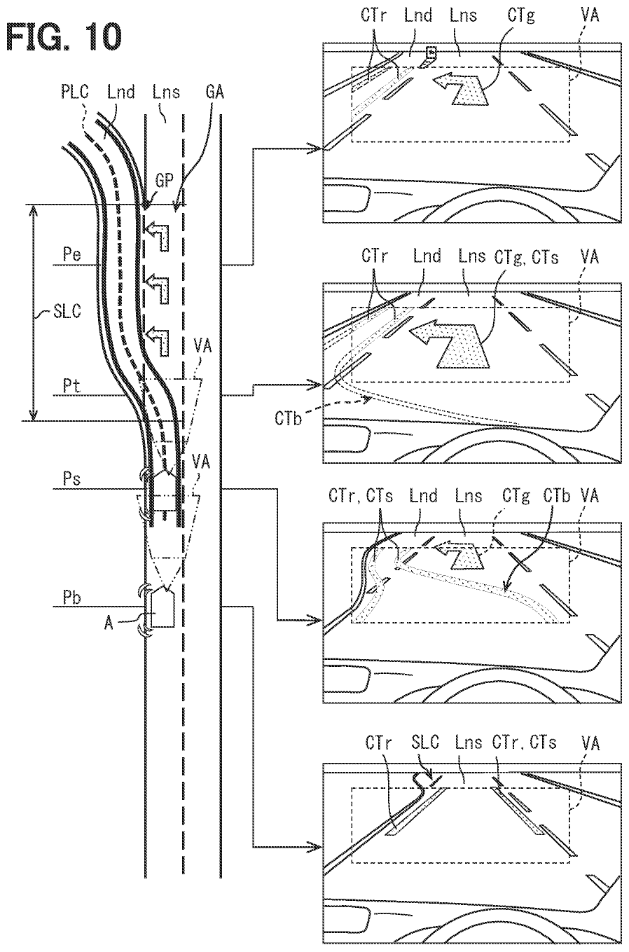

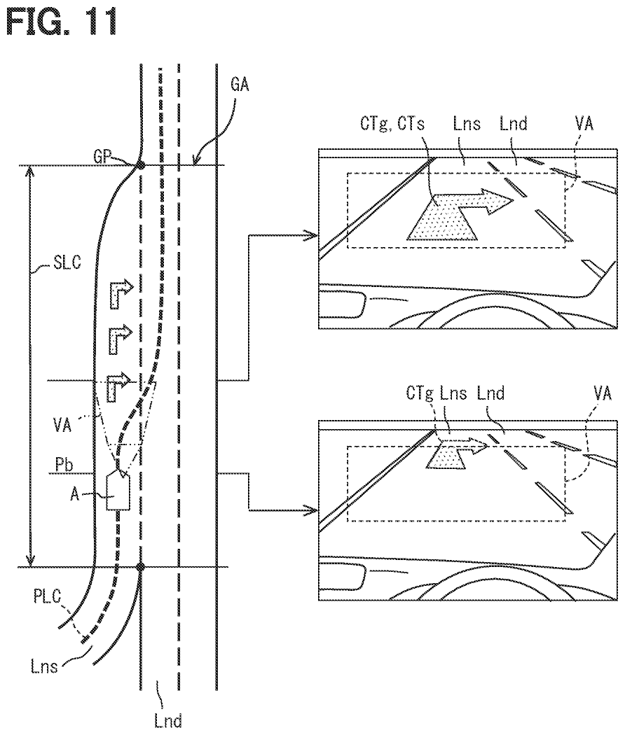

The content selecting function is a function of selecting a content used for, for example, information presentation. The display generation unit 76 selects a content rendered in picture data according to a simulation result of a display layout, a remaining distance Dr from the vehicle A to a reference point GP shown in FIG. 5 and FIG. 6, the presence or absence of a preceding car Ax, and the like. The reference point GP refers to a specific point in a guidance area GA defined in high-precision map data. For example, at a branch point, an end of a lane change section SLC (Refer to FIG. 10) where a lane change from the subject vehicle's lane Lns to an adjacent lane Lnd on a main lane roadway is allowed, at which end the subject vehicle's lane Lns and the adjacent lane Lnd depart from each other, is a reference point GP. At a merging point, an end of a lane change section SLC (Refer to FIG. 11) where a lane change to an adjacent lane Lnd on a main lane roadway is allowed, at which end the adjacent lane Lnd (merging lane) is terminated, is a reference point GP.

The display generation unit 76 properly uses a superimposed content CTs or a non-superimposed content CTn and provides route guidance display to guide a driver to a proper route at, for example, a branch point or a merging point. Hereafter, a detailed description will be given to this route guidance display based on FIG. 5 to FIG. 7 with reference to FIG. 3 and FIG. 4.

A content of route guidance display prompts a driver to make a manual lane change via steering operation or an automatic lane change via use of the LCA function. An example will be taken. The display generation unit 76 starts route guidance display triggered by acquisition of route information by the route information acquisition unit 73, reception of a guidance start request from the navigation device 55, or the like. In route guidance display, a route guidance icon CTi, an ideal route content CTr, a route guidance content CTg, and a highlighted content CTh are displayed as contents related to route guidance.

At the scene of approaching to a branch point shown in FIG. 5, the display generation unit 76 starts display of a route guidance icon CTi at an advance notice start point Pa where a remaining distance Dr from the vehicle A to a reference point GP falls below a predetermined distance (for example, 2 km). After start of display of the route guidance icon CTi, the display generation unit 76 terminates the display of the route guidance icon CTi when a predetermined time (for example, 5 seconds or so) has passed.

The route guidance icon CTi is a displayed item including an arrow-shaped image portion and a peripheral image portion. The arrow-shaped image portion indicates a direction of movement in a lane change at a branch point by a shape bent toward the adjacent lane Lnd side as a destination of movement at the branch point. The peripheral image portion annularly encircles the periphery of an arrow-shaped image portion. The route guidance icon CTi is a non-superimposed content CTn displayed slightly below the approximate center within a view angle VA. When the subject vehicle's lane Lns is straight, the route guidance icon CTi is superimposed on a road surface of the subject vehicle's lane Lns as viewed from the driver.

The display generation unit 76 starts display of an ideal route content CTr at a guiding start point Ps where a road surface of an adjacent lane Lnd as a destination of movement at a branch point comes to within a view angle VA based on a result of display layout simulation. The ideal route content CTr is a superimposed content CTs indicating a lane change trajectory PLC based on route information. The ideal route content CTr is superimposed on a lane change trajectory PLC or on a road surface in proximity to a lane change trajectory PLC and is so shaped as to extend along the lane change trajectory PLC. Thus, the ideal route content makes a driver grasp a shape of the lane change trajectory PLC. A lane change trajectory PLC at a branch point is defined in such a shape as to recommend traversing in the nearest one of sections where a lane change is possible. This is because a risk of a lane change being hindered by a parallel running car is substantially eliminated by completing the lane change in the nearest section.

The ideal route content CTr has its rendering shape determined based on a first virtual object VO1 and includes a pair of guidance lines extended in a narrow strip shape. Each guidance line is so shaped that the guidance line is curved and extended from the vicinity of both edges of the subject vehicle's lane Lns toward an adjacent lane Lnd. The ideal route content CTr moves downward (rearward) together with a road surface of the subject vehicle's lane Lns in conjunction with running of the vehicle A.

When a portion of an ideal route content CTr superimposed on a road surface of the subject vehicle's lane Lns is taken as a front part CTb, the display generation unit 76 starts display of a route guidance content CTg at a display transition point Pt where the front part CTb exits a view angle VA. In other words, during a period during which a front part CTb is within a view angle VA, the display generation unit 76 keeps a route guidance content CTg (Refer to broken line in FIG. 5) in a non-displayed state. Also, after the front part CTb exits the view angle VA, the display generation unit 76 continues display of a part of an ideal route content CTr that remains within the view angle VA and is superimposed on a road surface of an adjacent lane Lnd.

Like the ideal route content CTr, the route guidance content CTg is a superimposed content CTs capable of providing route guidance based on route information. Unlike the ideal route content CTr, the route guidance content CTg is superimposed also in a position deviated from a lane change trajectory PLC. While the ideal route content CTr is a content that indicates not only a direction of movement of the vehicle A but also desired movement start timing, the route guidance content CTg is a content that indicates a recommended direction of movement during a movement permitted period. While the ideal route content CTr can be superimposed across road surfaces of a plurality of lanes, the route guidance content CTg in the first embodiment is superimposed limitedly and mainly on a road surface of the subject vehicle's lane Lns.

The route guidance content CTg has its rendering shape determined based on a second virtual object VO2. The route guidance content CTg is displayed in a traveling direction of the front part CTb. The route guidance content CTg is superimposed and displayed at the approximate center of a road surface of the subject vehicle's lane Lns. The route guidance content CTg moves downward (rearward) together with a road surface of the subject vehicle's lane Lns in conjunction with running of the vehicle A. When one route guidance content CTg moves out of a view angle VA, the next route guidance content CTg come to within the view angle VA from above.

Like the route guidance content CTg, the highlighted content CTh is a superimposed content CTs indicating a direction of movement indicated by route information. While the route guidance content CTg is superimposed mainly on the subject vehicle's lane Lns, the highlighted content CTh in the first embodiment is superimposed only on a road surface of an adjacent lane Lnd or a destination of guidance lane Lng as a destination of movement to highlight the destination of guidance.

The display generation unit 76 continues display of an ideal route content CTr and a route guidance content CTg until the vehicle A arrives at a guiding limit point Pe where a lane change from the subject vehicle's lane Lns to an adjacent lane Lnd is infeasible. When the vehicle A arrives at a guiding limit point Pe without moving to an adjacent lane Lnd, the display generation unit 76 brings the ideal route content CTr and the route guidance content CTg into a non-displayed state to terminate the route guidance display.

The display generation unit 76 terminates route guidance display before the navigation device 55 (Refer to FIG. 1) initiates a reroute and route guidance by screen display is terminated. The display generation unit 76 may determine the vehicle A's arrival at a guiding limit point Pe via an internal counter or may determine the vehicle A's arrival at a guiding limit point Pe based on a termination request from such an external device as the navigation device 55.

At the scene of approaching to a branch point shown in FIG. 6, a preceding car Ax is present ahead of the vehicle A. A part of the preceding car Ax is visually recognized within a view angle VA by the driver. At such a scene, the display generation unit 76 discontinues superimposed display of an ideal route content CTr and a route guidance content CTg. Meanwhile, the display generation unit 76 displays a route guidance icon CTi and a highlighted content CTh.

Like cases where a preceding car Ax is not present, the display generation unit 76 initiates display of a route guidance icon CTi when the vehicle A arrives at an advance notice start point Pa. The display of the route guidance icon CTi is terminated before the vehicle A arrives at a guiding start point Ps after a predetermined time (for example, 5 seconds or so) after the start of the display.

The display generation unit 76 resumes display of a route guidance icon CTi at a guiding start point Ps where a road surface of an adjacent lane Lnd comes to within a view angle VA. In addition, the display generation unit 76 superimposes and displays a highlighted content CTh on a road surface of the adjacent lane Lnd. The highlighted content CTh is displayed in such a manner that the road surface is filled. A shape of the highlighted content CTh is successively updated according to a shape of a road surface of an adjacent lane Lnd located within the view angle VA. When the vehicle A continues running without making a lane change, the display generation unit 76 changes a display color of the highlighted content CTh as the vehicle A approaches a guiding limit point Pe.

The display generation unit 76 may coordinate display of a highlighted content CTh with voice guidance by the navigation device 55. For example, the display generation unit 76 causes the navigation device 55 to reproduce such a voice message as “go to the left lane ahead.” The display generation unit 76 terminates display of a route guidance icon CTi and a highlighted content CTh when the vehicle A arrives at a guiding limit point Pe.

Also, at the scene of approaching to a merging point shown in FIG. 7, the display generation unit 76 sequentially displays a route guidance icon CTi (Refer to FIG. 5), an ideal route content CTr, and a route guidance content CTg as at a scene of approaching to a branch point. A specific description will be given. The display generation unit 76 initiates display of an ideal route content CTr indicating a lane change trajectory PLC at a guiding start point Ps where a road surface of an adjacent lane Lnd as a destination of movement at a merging point comes to within a view angle VA.

A lane change trajectory PLC at a merging point is defined in such a shape that traversing is started at a point reached after running in a merging lane (the subject vehicle's lane Lns) for several seconds (2 to 3 seconds) among sections where a lane change is possible. This is for the purpose of ensuring a time for checking the situation of an adjacent lane Lnd located on the main lane side and avoiding an event in which a lane change becomes infeasible due to hindrance by a parallel running car.

The display generation unit 76 starts display of a route guidance content CTg at a display transition point Pt where the front part CTb of an ideal route content CTr exits a view angle VA. After the front part CTb exits the view angle VA, superimposed display of an ideal route content CTr to an adjacent lane Lnd is uninterruptedly continued. The display of the route guidance content CTg and the ideal route content CTr is terminated by the last route guidance content CTg exiting the view angle VA in conjunction with the vehicle A's approach to a reference point GP.

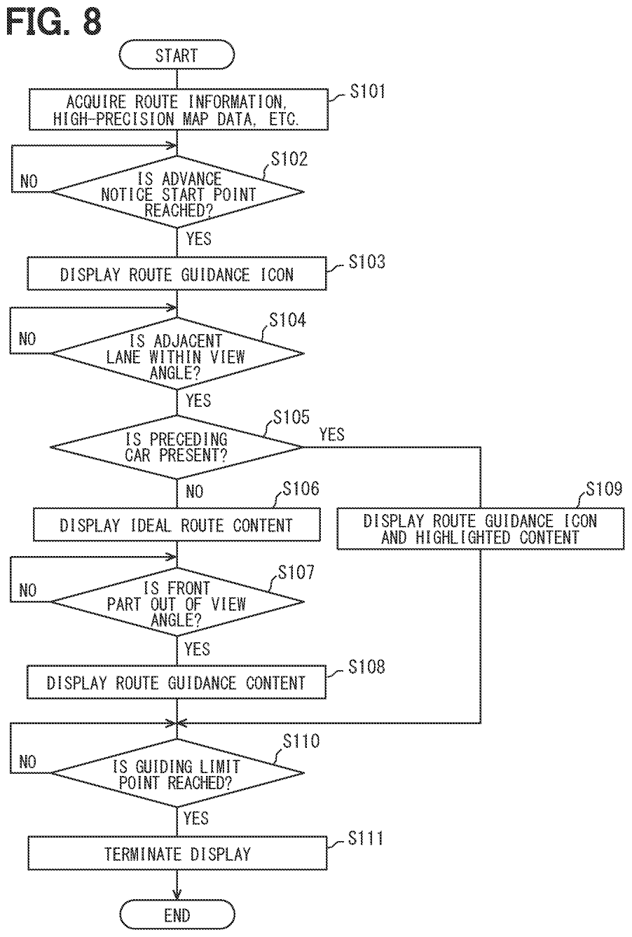

Hereafter, a detailed description will be given to the display control method for providing route guidance display, described up to this point, based on a flowchart shown in FIG. 8 with reference to FIG. 5 to FIG. 7. The display control processing shown in FIG. 8 is initiated by the HCU 100 that received route information or a guidance start request as mentioned above.

At S101, route information, high-precision map data, and the like required for route guidance are acquired and the processing proceeds to S102. At S102, the newest locator information is acquired and it is determined whether the vehicle A has arrived at an advance notice start point Pa based on a remaining distance Dr to a reference point GP. At S102, the vehicle A's arrival at the advance notice start point Pa is waited for and the processing proceeds to S103.

At S103, display of a route guidance icon CTi is started and the processing proceeds to S104. The display of the route guidance icon CTi started at S103 is terminated after a predetermined time passes. At S104, the newest locator information is acquired and it is determined whether the vehicle A has arrived at a guiding start point Ps. At S104, it is determined whether a road surface of an adjacent lane Lnd has come to within a view angle VA, from a result of display simulation incorporating locator information (positional information). At S104, the vehicle A's arrival at a guiding start point Ps is waited for and the processing proceeds to S105.

At S105, it is determined whether a preceding car Ax is present within the view angle VA. At S105, at least one of the following determinations is made: whether a preceding car Ax is present within a frontward range at a distance less than a predetermined distance from the subject vehicle based on preceding car information; and whether a preceding car Ax that can be visually recognized is present within the view angle VA based on a result of display simulation. When it determined at S105 that a preceding car Ax is present in a frontward area at a distance less than a predetermine distance from the subject vehicle or that a preceding car Ax that can be visually recognized is present within the view angle VA, the processing proceeds to S109. At S109, redisplay of the route guidance icon CTi and superimposed display of a highlighted content CTh are started and the processing proceeds to S110.

Meanwhile, when it is determined at S105 that the above-mentioned preceding car Ax as a target of determination is not present, the processing proceeds to S106. At S106, an ideal route content CTr presenting an ideal lane change trajectory PLC is displayed based on the route information acquired at S101 and the processing proceeds to S107.

At S107, the newest locator information is acquired and it is determined whether the vehicle A has arrived at a display transition point Pt. At S107, it is determined whether the front part CTb of the ideal route content CTr whose display was started at S106 has exited the view angle VA, based on a result of display simulation incorporating the newest locator information (positional information). At S107, the vehicle A's arrival at the display transition point Pt is waited for and the processing proceeds to S108. At S108, superimposed display of a route guidance content CTg is started and the processing proceeds to S110.

At S110, the newest locator information (positional information) is acquired and it is determined whether the vehicle A has arrived at a guiding limit point Pe. At S110, the vehicle A's arrival at the guiding limit point Pe is waited for and the processing proceeds to S111. At S111, the content display started at S106, S108, or S109 is terminated and the present display control processing is terminated.

In the first embodiment described up to this point, not only an ideal route content CTr indicating a lane change trajectory PLC is displayed; a route guidance content CTg providing route guidance is also superimposed and displayed in a position deviated from the lane change trajectory PLC. Therefore, at a scene of making movement in accordance with route guidance, different timing of making movement is permitted for each driver. When movement is made, at least any content CTr, CTg can be displayed. As a result, content display easy for a driver to recognize is implemented.

In the first embodiment, in addition, when the front part CTb of an ideal route content CTr superimposed on a road surface of the subject vehicle's lane Lns exits a view angle VA, superimposed display of a route guidance content CTg is started. According to the foregoing, since an ideal route content CTr and a route guidance content CTg are displayed together, an event in which a content is difficult for a driver to visually recognize is avoided.

Further, since a route guidance content CTg is displayed following the front part CTb, a presentation of a direction of movement to a driver does not vanish and is continued even when a lane change is made ahead of a lane change trajectory PLC. Consequently, an information presentation highly convenient for a driver is implemented.

In the first embodiment, the presence/absence of a preceding car Ax is determined. Only when it is determined that a preceding car Ax is not present, the display generation unit 76 superimposes and displays an ideal route content CTr. According to the foregoing, an event in which a displayed ideal route content CTr overlaps with a preceding car Ax and visual recognition of the preceding car Ax is hindered is avoided.

In the first embodiment, when it is determined that a preceding car Ax is present, the display generation unit 76 superimposes and displays a highlighted content CTh highlighting an adjacent lane Lnd as a destination of guidance on a road surface of the adjacent lane Lnd. By highlighting an adjacent lane Lnd as mentioned above, the display generation unit 76 is capable of accessibly prompting a driver to make a lane change without superimposing and displaying an ideal route content CTr on a road surface of the subject vehicle's lane Lns.

In addition, route guidance display using the HUD 20 in the first embodiment is terminated when the vehicle A arrives at a guiding limit point Pe located upstream from a reference point GP. Meanwhile, the navigation device 55 terminates route guidance by screen display in the navigation display 56 in agreement with execution of a reroute after the vehicle A passes the reference point GP.

As described up to this point, when the vehicle A is about to pass a reference point GP without obeying route guidance, the HUD 20 is capable of causing the navigation device 55 continuing display to terminate or change the route guidance display at the discretion of the HUD. As a result, an event in which guiding for a lane change by a route guidance content CTg is continued even when it is difficult to obey route guidance and the driver is confused is avoided. As a result, content display easy for a driver to recognize is implemented.

In the first embodiment, a preceding car Ax is equivalent to “other vehicle,” and the navigation device 55 is equivalent to “guidance device.” An ideal route content CTr is equivalent to “acquired route content”; the locator information acquisition unit 72 is equivalent to “positional information acquisition unit”; the display generation unit 76 is equivalent to “frontward determination unit” and “display control unit”; and the HCU 100 is equivalent to “display control device.”

### Second Embodiment

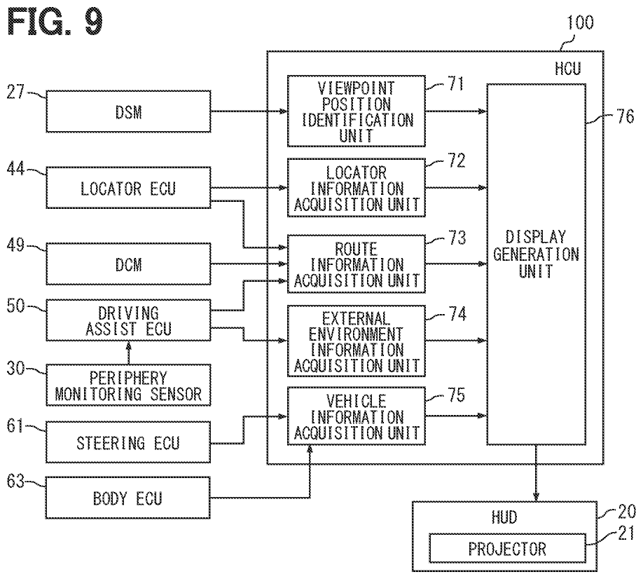

The second embodiment of the present disclosure shown in FIG. 9 to FIG. 13 is a modification to the first embodiment. In the second embodiment, the details of route guidance display are changed according to the presence/absence of a driver input related to a lane change. In the second embodiment, in addition, the details of route guidance display are changed between a scene of departing from a main lane roadway (Refer to FIG. 10) and a scene of merging into a main lane roadway (Refer to FIG. 11).

In addition to the viewpoint position identification unit 71, the locator information acquisition unit 72, the route information acquisition unit 73, the external environment information acquisition unit 74, the display generation unit 76, and the like, a vehicle information acquisition unit 75 is built in the HCU 100. The vehicle information acquisition unit 75 acquires operation information related to a driver's operation. A specific description will be given. The vehicle information acquisition unit 75 acquires the above-mentioned steering information from the steering ECU 61 (Refer to FIG. 1) as operation information indicating steering operation. In addition, the vehicle information acquisition unit 75 acquires operating information indicating an operating state (on and off) of a turn signal lamp from the body ECU 63 (Refer to FIG. 1). The vehicle information acquisition unit 75 successively provides the acquired steering information and operating information to the display generation unit 76 as operation information indicating a driver input related to a lane change.

When a lane change section SLC is within a view angle VA of the HUD 20 and a turn signal lamp of the vehicle A is on, the display generation unit 76 displays an ideal route content CTr in a mode different from a normal mode. A specific description will be given. When a lane change section SLC is out of a view angle VA or when turn signal lamps are off, the display generation unit 76 displays an ideal route content CTr with a reference brightness as a normal mode. The display brightness of an ideal route content CTr in this case is set to substantially the same as that of a route guidance content CTg.

Meanwhile, when a lane change section SLC is within a view angle VA and a turn signal lamp is on, the display generation unit 76 displays a low-visibility ideal route content CTr with a display brightness lower than normal. An ideal route content CTr in this case is displayed with a lower brightness than that of a route guidance content CTg. The display generation unit 76 can use a steering angle of a steering as a driver input in place of an operating state of a turn signal lamp. In this case, when a lane change section SLC is within a view angle VA and steering operation for a lane change has been inputted, the display generation unit 76 displays a low-visibility ideal route content CTr.

In addition, when a lane change in a guidance area GA is a lane change departing from a main lane roadway, the display generation unit 76 permits display of both an ideal route content CTr and a route guidance content CTg in a normal mode. Meanwhile, when a lane change in a guidance area GA is a lane change merging into a main lane roadway, the display generation unit 76 limits display of one of an ideal route content CTr and a route guidance content CTg. Specifically, the display generation unit 76 permits normal display of a route guidance content CTg and limits display of an ideal route content CTr. In the second embodiment, display of an ideal route content CTr is discontinued.

A detailed description will be sequentially given to the above-mentioned display transition under control of the display generation unit 76 in the second embodiment based on FIG. 10 and FIG. 11 with reference to FIG. 9.

At such a scene of approaching to a branch point as shown in FIG. 10, the display generation unit 76 changes a target to be displayed from a route guidance icon CTi (Refer to FIG. 5) to an ideal route content CTr before a lane change section SLC comes to within a view angle VA (Refer to superimposition start point Pb in FIG. 10). Display of an ideal route content CTr is started in such a mode that superimposition is performed only on a road surface of the subject vehicle's lane Lns before a guiding start point Ps where a lane change section SLC, in other words, a road surface of an adjacent lane Lnd comes to within a view angle VA. Before a guiding start point Ps, the display generation unit 76 displays an ideal route content CTr regardless of an operating state of turn signal lamps.

When operating information acquired at the vehicle information acquisition unit 75 indicates that a turn signal lamp is on, the display generation unit 76 starts a mode change of the ideal route content CTr at a guiding start point Ps where a lane change section SLC comes to within a view angle VA. For example, the display generation unit 76 extends each tip of the ideal route content CTr toward an adjacent lane Lnd and gradually reduces a display brightness of the ideal route content CTr, thereby gradually the visibility of the content. The display generation unit 76 continues display of the ideal route content CTr with a brightness reduced to a predetermined display brightness.

As in the first embodiment, the display generation unit 76 starts display of a route guidance content CTg at a display transition point Pt where the front part CTb of the ideal route content CTr exits the view angle VA. The display generation unit 76 continues display of the ideal route content CTr and the route guidance content CTg until the vehicle A arrives at a guiding limit point Pe where a lane change from the subject vehicle's lane Lns to an adjacent lane Lnd becomes infeasible. When the vehicle A arrives at the guiding limit point Pe, the display generation unit 76 causes the ideal route content CTr and the route guidance content CTg to exit the view angle VA to terminate the display of these contents.

The display generation unit 76 may reduce a display brightness of an ideal route content CTr until the content is substantially brought into a non-displayed state at a guiding start point Ps. In this case, the display generation unit 76 gradually changes a superimposed content CTs as a target to be displayed from an ideal route content CTr to a route guidance content CT in a lane change section SLC.

At such a scene of approaching to a merging point as shown in FIG. 11, unlike a scene of approaching to a branch point, the display generation unit 76 discontinues display of an ideal route content CTr (Refer to FIG. 10). The display generation unit 76 sequentially displays a route guidance icon CTi (Refer to FIG. 5) and a route guidance content CTg at the merging point.

The display generation unit 76 starts display of the route guidance content CTg at a superimposition start point Pb where as the result of the vehicle A's going straight in a merging lane (the subject vehicle's lane Lns), the vehicle A can deviate from an ideal lane change trajectory PLC. As the vehicle A approaches a reference point GP, the display generation unit 76 continues route guidance display at a merging point until the last route guidance content CTg exits the view angle VA. Display of a route guidance icon CTi may be continued until a guiding start point Ps or may be terminated at a predetermined distance upstream from the guiding start point Ps.

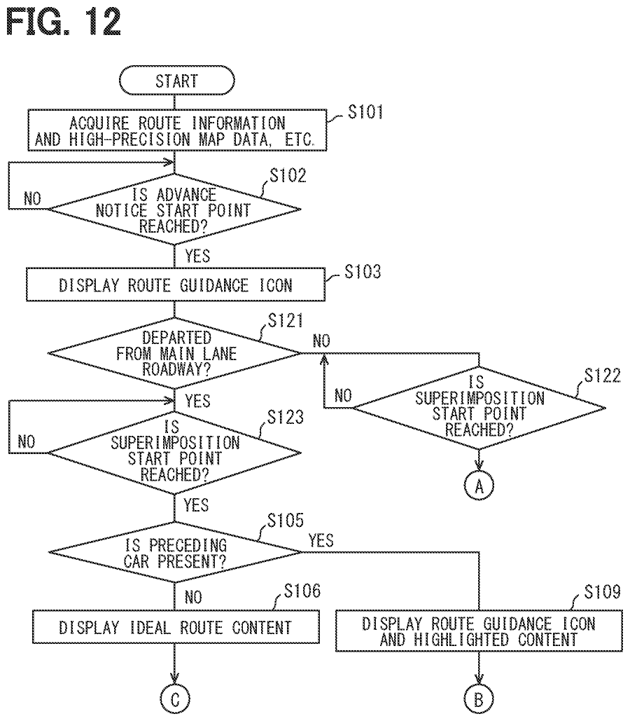

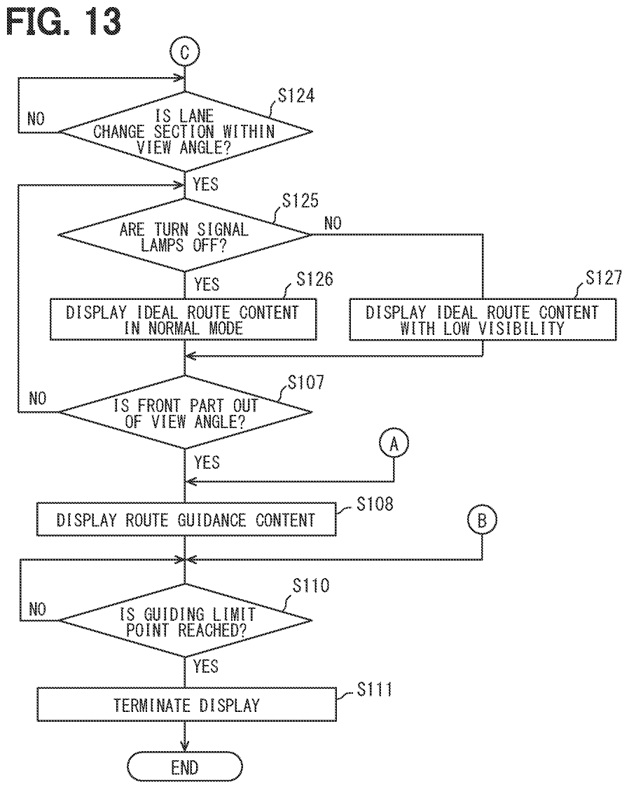

A detailed description will be given to the display control method for providing route guidance display in the second embodiment, described up to this point, based on flowcharts shown in FIG. 12 and FIG. 13 with reference to FIG. 9 to FIG. 11. In the following description, an explanation of a step for performing substantially the same processing as in the first embodiment may be omitted.

At S121 following S103 at which a route guidance icon CTi is displayed, it is determined whether a planned lane change is a lane change departing from a main lane roadway. When a lane change merging into a main lane roadway is planned, the processing proceeds from S121 to S122. At S122, it is determined whether the vehicle A has arrived at a superimposition start point Pb during merging. When it is determined at S122 that the vehicle A has arrived at the superimposition start point Pb, the processing proceeds to S108 and display of a route guidance content CTg is started.

Meanwhile, when a lane change departing from a main lane roadway is planned, the processing proceeds from S121 to S123. At S123, it is determined whether the vehicle A has arrived at a superimposition start point Pb during departure. When it is determined at S123 that the vehicle A has arrived at the superimposition start point Pb, content display corresponding to the presence or absence of a preceding car is started by the processing of S105, S106, and S109.

At S124 performed when a preceding car Ax is not present, it is determined whether a lane change section SLC is within a view angle VA. S124 is substantially identical with S104 (Refer to FIG. 8) in the first embodiment. When it is determined at S124 that a lane change section SLC is within the view angle VA, the processing proceeds to S125.

At S125, an operating state of turn signal lamps is determined. When it is determined at S125 that turn signal lamps are off, the processing proceeds to S126. At the step, an ideal route content CTr is displayed in a normal mode and the processing proceeds to S107. Meanwhile, when it is determined at S125 that a turn signal lamp is on, the processing proceeds to S127. At the step, an ideal route content CTr is displayed with lower visibility than normal and the processing proceeds to S107. At S125 mentioned above, it may be determined whether a steering angle has exceeded a threshold value as a driver input related to a lane change.

At S107, it is determined whether the front part CTb of the ideal route content CTr has exited the view angle VA. The display of the ideal route content CTr is continued until it is determined at S107 that the front part CTb has exited the view angle VA. After a route guidance content CTg is displayed by the processing of S108 to S111, a series of processing of route guidance display is terminated based on arrival at a guiding limit point Pe.

Also, in the second embodiment described up to this point, the same effects as in the first embodiment are brought about and when movement to an adjacent lane Lnd is made, an ideal route content CTr or a route guidance content CTg can be presented. Therefore, content display easy for a driver to recognize is implemented.

In the second embodiment, in addition, when a turn signal lamp is on or when steering operation for a lane change is inputted, an ideal route content CTr is displayed in a mode with low visibility or display of the content is discontinued. According to the foregoing, an event in which in spite of that a driver becomes aware of necessity for a lane change and tries a lane change with a lane change section SLC visually recognized, an information presentation strongly prompting a lane change is made by an ideal route content CTr and a route guidance content CTg is avoided. As a result, an information presentation less irritating for a driver can be made.

In the second embodiment, when a lane change merging into a main lane roadway is made, display of an ideal route content CTr is limited. At a scene of merging into a main lane roadway, a driver has substantially no other choice but to merge into the main lane roadway and is prevented from selecting a wrong route. By reducing types of displayed contents when a driver's choices are limited, an information presentation can be made less irritating for the driver. Meanwhile, when two actions, making a lane change or not, are selectable, like when a departure from a main lane roadway is made, a driver can be made recognize a correct route by an information presentation with a combination of an ideal route content CTr and a route guidance content CTg.

<Modifications 1 to 10>

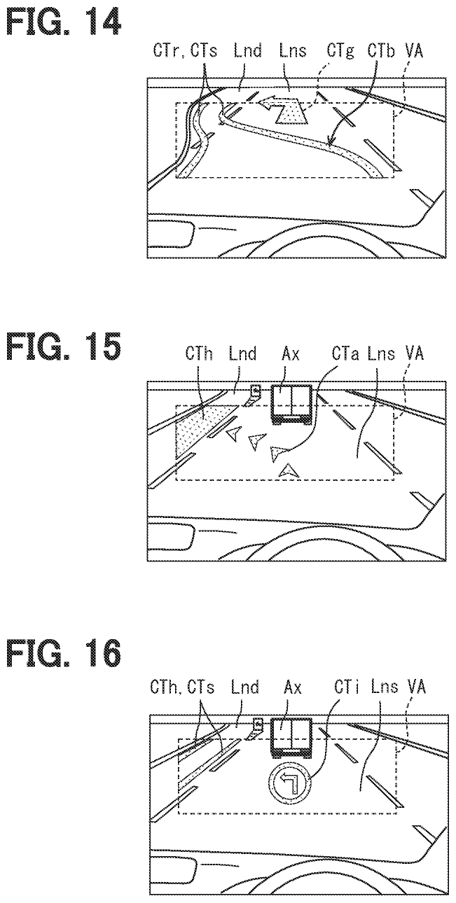

In Modification 1 to the first embodiment, a display transition point Pt (Refer to FIG. 5) is not established. In Modification 1, display of a route guidance content CTg is also started when the front part CTb of an ideal route content CTr comes to within a view angle VA as shown in FIG. 14. The route guidance content CTg is disposed in a traveling direction of the front part CTb and is superimposed and displayed on a road surface of the subject vehicle's lane Lns. The route guidance content CTg is sequentially displayed within the view angle VA from the base end portion of the content.

In Modification 2 to the first embodiment, after arrival at a guiding start point Ps (Refer to FIG. 6), such a route guidance animation CTa as shown in FIG. 15 is displayed in place of a route guidance icon CTi (Refer to FIG. 6). The route guidance animation CTa is a non-superimposed content CTn similar to a route guidance icon CTi. The route guidance animation CTa is a content guiding a lane change to an adjacent lane Lnd by a triangular displayed item repeatedly flowing from the subject vehicle's lane Lns toward an adjacent lane Lnd.

Modification 3 to the first embodiment is different from the first embodiment in a display shape of the highlighted content CTh. As shown in FIG. 16, a highlighted content CTh in Modification 3 includes two displayed items in a narrow strip shape superimposed in the vicinity of left and right borders on a road surface of an adjacent lane Lnd. As in Modification 3, a technique for highlighting a highlighted content CTh may be appropriately modified as long as the highlighted content is a superimposed content CTs capable of highlighting an adjacent lane Lnd as a destination of guidance versus the subject vehicle's lane Lns.

A display transition point Pt (Refer to FIG. 5) in Modification 4 to the first embodiment is so established that when an entire ideal route content CTr exits a view angle VA, superimposed display of a route guidance content CTg is started. For example, when a view angle VA of the HUD 20 in the horizontal direction is narrower than in the above-mentioned established mode, such a display transition point Pt as in Modification 4 is established.

In Modification 5 to the first embodiment, a determination of the presence/absence of a preceding car Ax made when the vehicle A arrives at a guiding start point Ps is omitted. Even when a preceding car Ax is present, in Modification 5, route guidance display by an ideal route content CTr and a route guidance content CTg is provided.

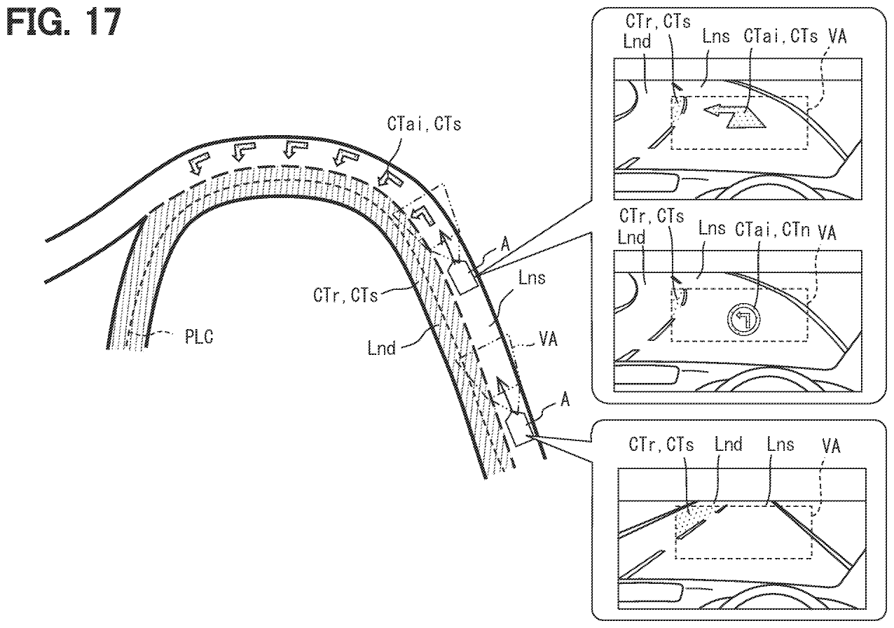

In Modification 6 to the first embodiment, as shown in FIG. 17, the display generation unit 76 determines a degree of overlapping between a road surface of an adjacent lane Lnd as a destination of movement (hereafter, referred to as “destination of movement road surface”) and a view angle VA during a lane change. In an example, a degree of overlapping is calculated by dividing an area of a region of a view angle VA overlapping with a destination of movement road surface as viewed from a driver by the total area of the view angle VA. In other words, a degree of overlapping is a ratio of a destination of movement road surface in a superimposition area SA (Refer to FIG. 4) overlapping with a view angle VA.

When a degree of overlapping is less than a threshold value (for example, 10%), the display generation unit 76 additionally displays an additional information content CTai guiding a lane change in addition to an ideal route content CTr. The additional information content CTai is a content indicating a direction of movement in a lane change. The additional information content CTai may be such a non-superimposed content CTn as a route guidance icon CTi or may be such an arrow-shaped superimposed content CTs as a route guidance content CTg. When a degree of overlapping is not less than a threshold value, an additional information content CTai is not displayed. When an additional information content CTai is displayed as in Modification 6, even at a scene of making a left- or right-hand turn after a sharp curve, a driver can be understandably informed of the left- or right-hand turn after the sharp curve in advance.

In Modification 7 to the second embodiment, when a lane change section SLC is within a view angle VA and a turn signal lamp is on, the display generation unit 76 displays a flashing ideal route content CTr. A modification of display of an ideal route content CTr made when a turn signal lamp is on as in Modification 7 is not limited to processing of reducing a display brightness. According to flashing display reminding that a turn signal lamp is flashing, an ideal route content CTr becomes less irritating for a driver even when the driver is aware of execution of a lane change.

In Modification 8 to the second embodiment, a mode of an ideal route content CTr is modified based on determination of a steering state based on steering information, in place of determination of an operating state of turn signal lamps based on operating information (Refer to S125 in FIG. 13). Specifically, when steering operation for a lane change is started, the display generation unit 76 switches an ideal route content CTr from normal display to low-visibility display. Even in this case, an event in which an ideal route content CTr displayed with a normal brightness causes irritation of a driver can be avoided.

In Modification 9 to the second embodiment, at a scene of approaching to a merging point, the display generation unit 76 discontinues display of a route guidance content CTg of an ideal route content CTr (Refer to FIG. 7) and a route guidance content CTg (Refer to FIG. 7). In Modification 10 to the above embodiment, at a scene of approaching to a merging point, the display generation unit 76 displays an ideal route content CTr in a low-brightness mode in which visibility is lower than that of a route guidance content CTg or in other like modes. Also, in Modifications 9 and 10, at a scene at which a driver will not select a wrong route, an information presentation less irritating for a driver can be made.

### Third Embodiment

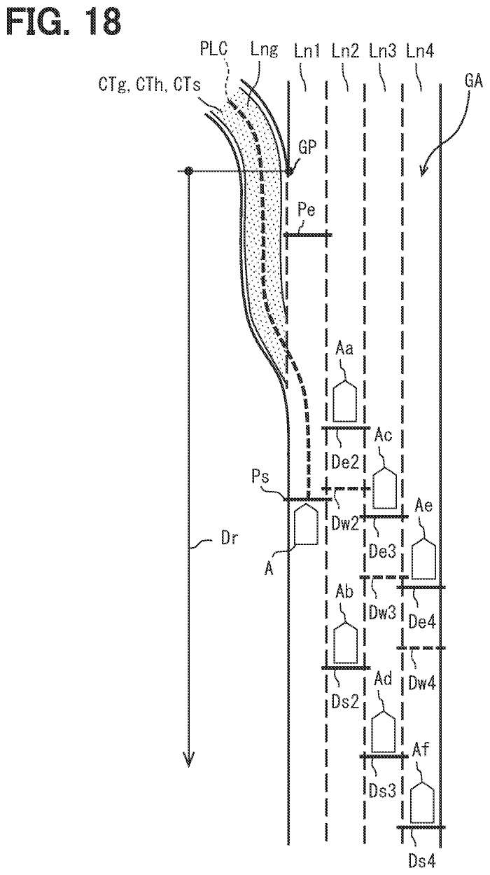

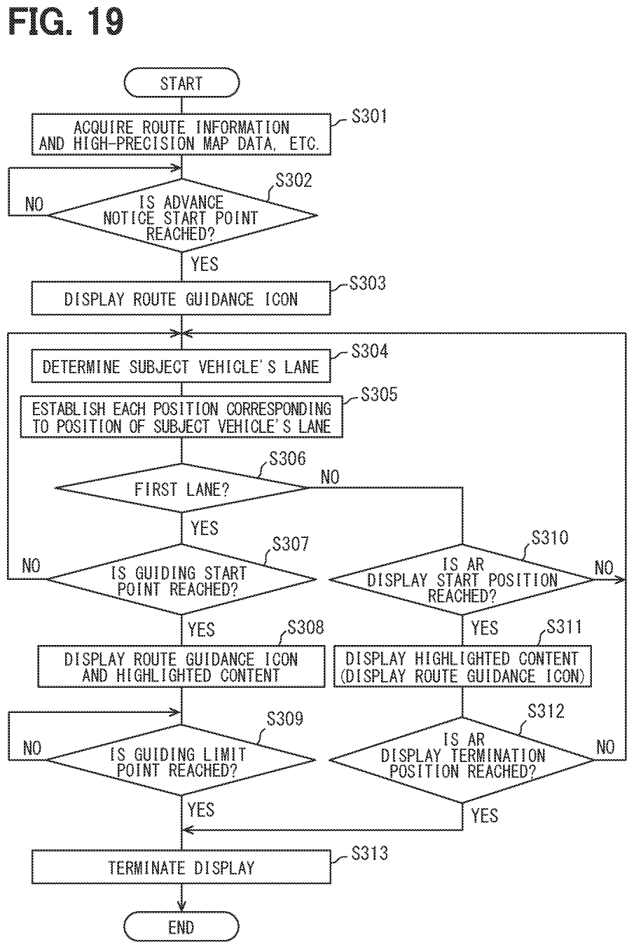

The third embodiment of the present disclosure shown in FIG. 18 and FIG. 19 is another modification to the first embodiment. Route guidance display in the third embodiment is provided at a scene at which the vehicle A runs on a road including a plurality of lanes. The details of the route guidance display are modified according to a position of the subject vehicle's lane Lns among the above lanes. Specifically, route guidance display is terminated with different timing from lane to lane. Hereafter, a detailed description will be given to route guidance display in the third embodiment based on FIG. 18 and FIG. 19 with reference to FIG. 1, FIG. 3, and FIG. 6.

A road in the following description is so structured as to include four lanes on the main lane side. However, a number of lanes may be appropriately varied. The four lanes are defined as first lane Ln1, second lane Ln2, third lane Ln3, and fourth lane Ln4 in the order of approximation to a destination of guidance lane Lng.

The display generation unit 76 grasps a position of the subject vehicle's lane Lns in which the vehicle A (the subject vehicle) runs among the above lanes based on locator information and high-precision map data acquired at the locator information acquisition unit 72. When the subject vehicle's lane Lns is the first lane Ln1, as in the first embodiment, the display generation unit 76 starts display of a route guidance icon CTi and a highlighted content CTh when the vehicle A arrives at a guiding start point Ps. As in the first embodiment, the highlighted content CTh is a superimposed content CTs superimposed on a road surface of a destination of guidance lane Lng and indicating a direction of movement of the vehicle A. In the third embodiment, the highlighted content CTh is one of route guidance contents CTg like the route guidance icon CTi.

In the third embodiment, a route guidance icon CTi and a highlighted content CTh are both included in a route guidance content CTg. As mentioned above, a route guidance content CTg may be a superimposed content CTs or may be a non-superimposed content CTn.

In cases where the vehicle A continues to run in the first lane Ln1, the display generation unit 76 continuously display the highlighted content CTh even when the vehicle A is brought closer to a reference point GP than an AR display termination position De2 to De4 described later. When the vehicle A passes by a guiding limit point Pe without making a lane change to a destination of guidance lane Lng, the display generation unit 76 terminates the display of the route guidance icon CTi and the highlighted content CTh.

When the subject vehicle's lane Lns is not the first lane Ln1, the display generation unit 76 establishes an AR display start position, a caution display transition position, and an AR display termination position corresponding to a position of the subject vehicle's lane Lns. A specific description will be given. When the vehicle A is running in the second lane Ln2, the display generation unit 76 establishes an AR display start position Ds2, a caution display transition position Dw2, and an AR display termination position De2. Similarly, the display generation unit 76 establishes each position Ds3, Dw3, De3 when the vehicle A is running in the third lane Ln3 and establishes each position Ds4, Dw4, De4 when the vehicle A is running in the fourth lane Ln4.

In each AR display start position Ds2 to Ds4, display of a route guidance content CTg is started. A route guidance content CTg whose display is started at an AR display start position Ds2 to Ds4 is a superimposed content CTs superimposed and displayed on a road surface in the foreground and is a highlighted content CTh highlighting a destination of guidance lane Lng. As in the first embodiment, a highlighted content CTh is superimposed and displayed in such a mode that a road surface of a destination of guidance lane Lng is filled.

At this time, a highlighted content CTh in a different mode from that in the first embodiment may be displayed as a route guidance content CTg. In an example, a highlighted content CTh may be superimposed and displayed not only on a road surface of a destination of guidance lane Lng but also on a road surface of the subject vehicle's lane Lns. Further, a highlighted content CTh may be displayed in such a mode that the content is extended as a single wide belt or two narrow strips from the subject vehicle's lane Lns to a destination of guidance lane Lng. A highlighted content CTh may be an arrow-shaped displayed item superimposed on a road surface of at least one of a destination of guidance lane Lng and the subject vehicle's lane Lns.

An AR display start position Ds2 to Ds4 is established in a position where start of a lane change toward a destination of guidance lane Lng is recommended. For this reason, an AR display start position Ds2 to Ds4 is established in a position farther from a reference point GP as the subject vehicle's lane Lns becomes farther from a destination of guidance lane Lng. That is, a remaining distance Dr from a reference point GP to the AR display start position Ds4 is longer than a remaining distance Dr from the reference point GP to the AR display start position Ds3. Similarly, a remaining distance Dr from the reference point GP to the AR display start position Ds3 is longer than a remaining distance Dr from the reference point GP to the AR display start position Ds2.

In a caution display transition position Dw2 to Dw4, a display mode of a route guidance content CTg is varied. An example will be taken. In a caution display transition position Dw2 to Dw4, flashing display of a highlighted content CTh is started. The flashing display of the highlighted content CTh warns the driver of the approach of a limit line on which arrival at a destination of guidance lane Lng becomes infeasible. The caution display transition positions Dw2 to Dw4 are respectively established between the AR display start positions Ds2 to Ds4 and the AR display termination positions De2 to De4.

In an AR display termination position De2 to De4, superimposed display of a highlighted content CTh is terminated. An AR display termination position De2 to De4 is established in a position where arrival at a destination of guidance lane Lng via a lane change becomes substantially infeasible. Therefore, an AR display termination position De2 to De4 is established in a position farther from a reference point GP as the subject vehicle's lane Lns becomes farther from a destination of guidance lane Lng. That is, a remaining distance Dr from a reference point GP to the AR display termination position De4 is longer than a remaining distance Dr from the reference point GP to the AR display termination position De3. Similarly, a remaining distance Dr from the reference point GP to the AR display termination position De3 is longer than a remaining distance Dr from the reference point GP to the AR display termination position De2.

The display generation unit 76 is capable of correcting an AR display termination position De2 to De4 established based on high-precision map data based on detection information from the periphery monitoring sensor 30. An example will be taken. In a running environment with a high amount of traffic and crowded with vehicles, a level of difficulty in lane change is prone to be increased. To cope with this, an AR display termination position De2 to De4 is established in a position farther from a reference point GP as compared with a standard position.

Hereafter, a detailed description will be given to the display control method for providing route guidance display in the third embodiment based on a flowchart in FIG. 19. The processing of each step of S301 to S303 in the display control processing shown in FIG. 19 is substantially identical with the processing of each step of S101 to S103 (Refer to FIG. 8) in the first embodiment.

At S304, a position of the subject vehicle's lane Lns is determined based on lane-specific information acquired by the route information acquisition unit 73 as positional information of the vehicle A and the processing proceeds to S305. At S305, respective positions of a guiding start point Ps and a guiding limit point Pe, an AR display start position Ds3 to Ds4, a caution display transition position Dw2 to Dw4, and an AR display termination position De2 to De4 are established in correspondence with the position of the subject vehicle's lane Lns grasped at S304 and the processing proceeds to S306.

At S306, it is determined whether the position of the subject vehicle's lane Lns determined at S304 is in the first lane Ln1. When it is determined at S306 that the subject vehicle's lane Lns is the first lane Ln1, the processing proceeds to S307. At S307, the vehicle A's arrival at the guiding start point Ps is waited for and the processing proceeds to S308. At S308, display of a route guidance icon CTi and a highlighted content CTh is started and the processing proceeds to S309. At S309, the vehicle A's arrival at the guiding limit point Pe is waited for and the processing proceeds to S313. At S313, the display of the route guidance icon CTi and the highlighted content CTh is terminated and the present display control processing is terminated.

Meanwhile, when it is determined at S306 that the position of the subject vehicle's lane Lns is not in the first lane Ln1, the processing proceeds to S310. At S310, the vehicle A's arrival at the AR display start position Ds3 to Ds4 is waited for and the processing proceeds to S311. At S311, superimposed display of a highlighted content CTh is started and the processing proceeds to S312. At S311, when the vehicle A arrives at each AR display termination position De2 to De4, a display mode of the highlighted content CTh is caused to transition to an alerting mode. At S311, as at S308, the display may be caused to transition to a state in which both the route guidance icon CTi and the highlighted content CTh are displayed. At S312, the vehicle A's arrival at the AR display termination position De2 to De4 is waited for and the processing proceeds to S313. At S313, the display of the highlighted content CTh is terminated and the present display control processing is terminated.

According to the processing of S305 and S310 to S312 mentioned above, display control on a route guidance content CTg is varied in correspondence with a position of the subject vehicle's lane Lns. As a result, when the vehicle A runs in the second lane Ln2, display of a highlighted content CTh is started in a position corresponding to the vehicle Ab that passed the AR display start position Ds2 and terminated in a position corresponding to the vehicle Aa that passed the AR display termination position De2. Similarly, when the vehicle A runs in the third lane Ln3, display of a highlighted content CTh is started in a position corresponding to the vehicle Ad that passed the AR display start position Ds3 and terminated in a position corresponding to the vehicle Ac that passed the AR display termination position De. Further, when the vehicle A runs in the fourth lane Ln4, display of a highlighted content CTh is started in a position corresponding to the vehicle Af that passed the AR display start position Ds4 and terminated in a position corresponding to the vehicle Ae that passed the AR display termination position De4.

In the third embodiment described up to this point, on a road including a plurality of lanes, display control on a route guidance content CTg used in route guidance is varied according to a position of the subject vehicle's lane Lns. By appropriately controlling display timing of a route guidance content CTg in accordance with a position of the subject vehicle's lane Lns as mentioned above, content display easy for a driver to recognize is implemented.

In the third embodiment, in addition, in cases where a destination of guidance lane Lng and the subject vehicle's lane Lns do not adjoin to each other, display of a highlighted content CTh is terminated when a remaining distance Dr is less than a distance from a reference point GP to each AR display termination position De2 to De4 (hereafter, referred to as “termination threshold value”). Therefore, after arrival at a destination of guidance lane Lng becomes substantially difficult, route guidance prompting a driver to make a lane change is not provided.

Meanwhile, when a destination of guidance lane Lng and the subject vehicle's lane Lns adjoin to each other, a highlighted content CTh is superimposed and displayed even in such a section that a remaining distance Dr is less than the termination threshold value. According to the foregoing, during a period during which movement from the first lane Ln1 to a destination of guidance lane Lng is possible, a lane change can be continuously prompted using a highlighted content C1.

In the third embodiment, even when a destination of guidance lane Lng and the subject vehicle's lane Lns do not adjoin to each other, a highlighted content CTh is superimposed and displayed as long as a remaining distance Dr exceeds the termination threshold value. According to the foregoing, even when the subject vehicle's lane Lns is away from a destination of guidance lane Lng, route guidance display capable of understandably guiding the vehicle A to the destination of guidance lane Lng is implemented.

In the third embodiment, as mentioned above, a distance from a reference point GP to each AR display termination position De2 to De4 is equivalent to “termination threshold value.” Locator information and lane-specific information are equivalent to “positional information,” and the locator information acquisition unit 72 and the external environment information acquisition unit 74 are equivalent to “positional information acquisition unit.”

### Fourth Embodiment

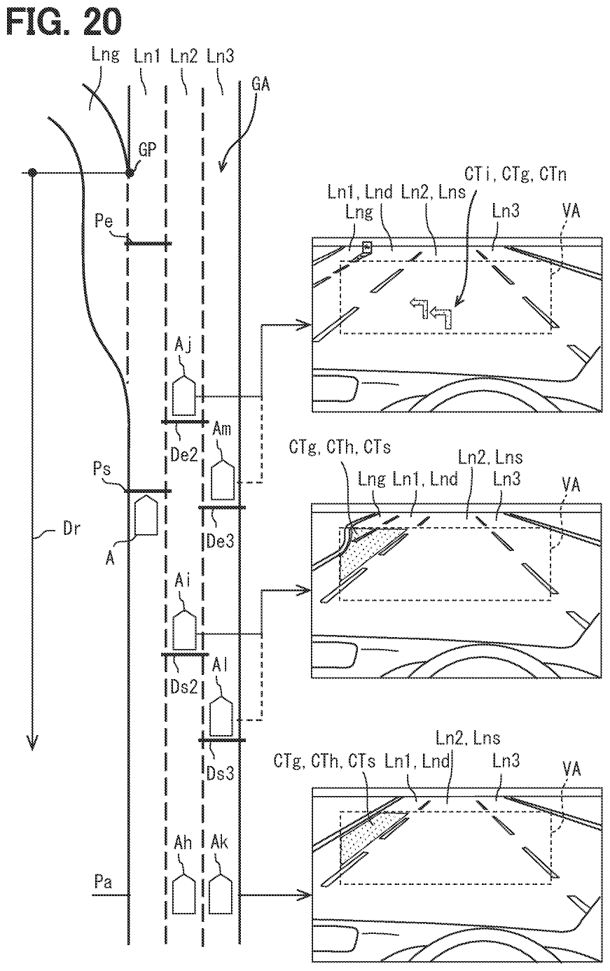

The fourth embodiment of the present disclosure shown in FIG. 20 is a modification to the third embodiment. Also, in the fourth embodiment, the details of route guidance display are modified according to a position of the subject vehicle's lane Lns. Hereafter, a detailed description will be given to route guidance display in the fourth embodiment based on FIG. 20 with reference to FIG. 3 and FIG. 19.

When the vehicle A is running in the first lane Ln1 and it is determined that a destination of guidance lane Lng and the subject vehicle's lane Lns adjoin to each other (Refer to S306), the display generation unit 76 establishes an advance notice start point Pa, a guiding start point Ps, and a guiding limit point Pe. As in the first embodiment, the display generation unit 76 starts display of a route guidance icon CTi at the advance notice start point Pa (Refer to FIG. 6). Then, the display generation unit 76 starts superimposed display of a highlighted content CTh and the like at the guiding start point Ps (Refer to S307 and S308) and terminates display of the highlighted content CTh and the like at the guiding limit point Pe (Refer to S309 and S310).

Meanwhile, when the vehicle A is running in the second lane Ln2 or the third lane Ln3, the display generation unit 76 starts display of a highlighted content CTh as a route guidance content CTg at the advance notice start point Pa (Refer to the vehicle Ah, Ak). This highlighted content CTh is a superimposed content CTs superimposed and displayed on a road surface of the adjacent lane Lnd (for example, the first lane Ln1 or the like) located on the destination of guidance lane Lng side relative to the subject vehicle's lane Lns.

In addition, the display generation unit 76 establishes an AR display start position Ds2, Ds3 and an AR display termination position De2, De3. The display generation unit 76 expands a superimposition area of the highlighted content CTh at the AR display start position Ds2, Ds3 where a road surface of a destination of guidance lane Lng comes to within the view angle VA (Refer to the vehicle Ai, Al). The highlighted content CTh is superimposed and displayed on not only a road surface of an adjacent lane Lnd but also a road surface of the destination of guidance lane Lng.

A route guidance content CTg displayed after passage by the AR display start position Ds2, Ds3 is not limited to a highlighted content CTh. For example, an arrow-shaped superimposed content CTs pasted on the subject vehicle's lane Lns, a route guidance icon CTi in the first embodiment (Refer to FIG. 5), or the like may be displayed as a route guidance content CTg after passage by the AR display start position Ds2, Ds3.

When the vehicle A arrives at the AR display termination position De2, De3, the display generation unit 76 terminates superimposed display of the highlighted content CTh and changes the display control to route guidance using a non-superimposed content CTn. When the vehicle A passes the AR display termination position De2, De3, the display generation unit 76 starts display of a route guidance icon CTi (Refer to the vehicle Aj, Am). The route guidance icon CTi functions as a route guidance content CTg and includes arrow-shaped image portions in a number corresponding to a number of times of lane changes required for arrival at a destination of guidance lane Lng. For example, when the vehicle A is running in the second lane Ln2, two arrow-shaped image portions are included in the route guidance icon CTi.

Also, in the fourth embodiment described up to this point, the same effects as in the third embodiment are brought about and display control on a route guidance content CTg is appropriately modified according to a position of the subject vehicle's lane Lns. Therefore, content display easy for a driver to recognize is implemented.

In the fourth embodiment, in addition, even when a destination of guidance lane Lng and the subject vehicle's lane Lns do not adjoin to each other, superimposed display of a highlighted content CTh is provided until the vehicle A arrives at an AR display termination position De2, De3. According to the foregoing, during a period during which arrival at a destination of guidance lane Lng is possible, appropriate route guidance is provided for a driver.

In the fourth embodiment, in cases where a destination of guidance lane Lng does not adjoin to the subject vehicle's lane Lns, a non-superimposed route guidance content CTg is displayed when the vehicle A approaches a reference point GP beyond an AR display termination position De2, De3. Therefore, even when arrival at a destination of guidance lane Lng leading to a highway exit or the like is difficult, the contents of route guidance display imply that the situation has transitioned to a situation in which the arrival is difficult and further continuously present a destination of movement. In the fourth embodiment, a distance from a reference point GP to each AR display termination position De2, De3 is equivalent to “termination threshold value.”

### Fifth Embodiment

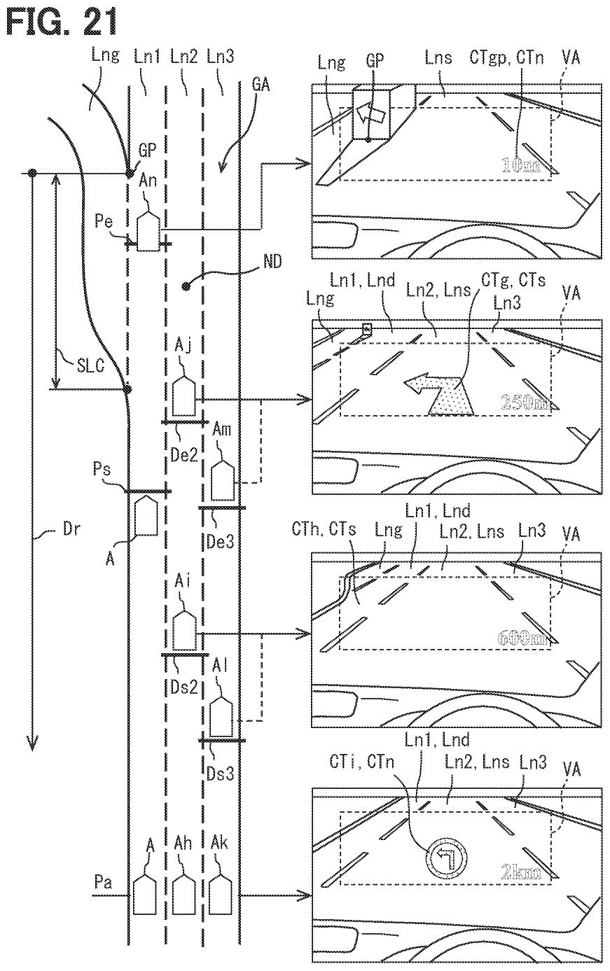

The fifth embodiment of the present disclosure shown in FIG. 21 is a modification to the fourth embodiment. The fifth embodiment is different from the fourth embodiment in a style of each content taken when the subject vehicle's lane Lns does not adjoin to a destination of guidance lane Lng. In route guidance display according to the fifth embodiment, display of a route guidance icon CTi is started in conjunction with the vehicle A's passage by an advance notice start point Pa (Refer to the vehicle Ah, Ak).

When the vehicle A arrives at the AR display start position Ds2, Ds3, superimposed display of a highlighted content CTh is started (Refer to the vehicle Ai, Al). The highlighted content CTh in the fifth embodiment is superimposed only on a road surface of an adjacent lane Lnd but is not superimposed on a road surface of a destination of guidance lane Lng.

When the vehicle A arrives at the AR display termination position De2, De3, in place of the highlighted content CTh, superimposed display of a route guidance content CTg in a different style from that of the highlighted content CTh is started (Refer to the vehicle Aj, Am). For example, an arrow-shaped superimposed content CTs is superimposed as a route guidance content CTg on a road surface of the subject vehicle's lane Lns. When the vehicle A is running in the second lane Ln2 or the third lane Ln3, an additional notification related to movement to a destination of guidance lane Lng is made in association with the start of display of the arrow-shaped route guidance content CTg. The additional notification may be made at substantially the same time as the start of display of the arrow-shaped route guidance content CTg or may be made slightly before or after the start of display of the arrow-shaped route guidance content CTg.

Specifically, the display generation unit 76 (Refer to FIG. 3) uses additional notification to enhance the visibility of a route guidance content CTg. For example, as an additional notification, the display generation unit 76 performs at least one of processing of causing a route guidance content CTg to flash, processing of increasing a display brightness, and processing of expanding a display size. Further, the display generation unit 76 is capable of reproducing a warning sound or a warning message alerting a driver as an additional notification in cooperation with a sound control functional unit of the HCU 100. The additional notification is configured as a notification alerting that arrival at a destination of guidance lane Lng is about to be difficult or that a physical dead limit of a lane change is approaching.

In addition to a highlighted content CTh, a route guidance content CTg, and the like, the display generation unit 76 displays an end notification content CTgp within a view angle VA. The end notification content CTgp is a non-superimposed content CTn numerically indicating a remaining distance Dr from the present position to a reference point GP. The end notification content CTgp causes a driver to grasp a position of the end of a lane change section SLC (reference point GP) where a lane change is physically possible in a guidance area GA, that is, a dead limit of a lane change. Display of an end notification content CTgp is started together with that of a route guidance icon CTi and continued until the vehicle A departs from the guidance area GA after passage by a guiding limit point Pe (Refer to the vehicle An). An end notification content CTgp is displayed, for example, on a lower corner of a view angle VA.

The display generation unit 76 gradually reduces a numeric value indicated by an end notification content CTgp in conjunction with the vehicle A's approach to a reference point GP. A numeric value of an end notification content CTgp is reduced stepwise, for example, by 5 m after passage by an AR display termination position De2, De3. Such a width of reduction in numeric value may be gradually reduced with approaching to a reference point GP.

The display generation unit 76 determines a value of remaining distance Dr presented by an end notification content CTgp based on high-precision map data. However, when high-precision map data cannot be acquired, the display generation unit 76 may present an end notification content CTgp using navigation map data. When navigation map data is used, the display generation unit 76 assumes that a reference point GP is located in a position a predetermined distance upstream from a node ND established, for example, in proximity to the center of a lane change section SLC or the like. The display generation unit 76 presents a distance to the assumed reference point GP by an end notification content CTgp.

Also, in the fifth embodiment mentioned above, the same effects as in the fourth embodiment are brought above and display control on a route guidance content CTg is appropriately modified according to a position of the subject vehicle's lane Lns. Therefore, content display easy for a driver to recognize is implemented.

In the fifth embodiment, in addition, when a destination of guidance lane Lng and the subject vehicle's lane Lns do not adjoin to each other, the intensity of actuation prompting a driver to make a lane change is set higher than in cases where these lanes adjoin to each other. According to the foregoing, a driver can be notified of the present situation of the vehicle A in a more recognizable manner.

In the fifth embodiment, further, a distance to a reference point GP as an end of a lane change section SLC is explicitly presented to a driver by an end notification content CTgp. According to the foregoing, a driver can precisely grasp the timing of a lane change being brought into a dead limit and easily and appropriately move the subject vehicle to a destination of guidance lane Lng.

### Sixth Embodiment

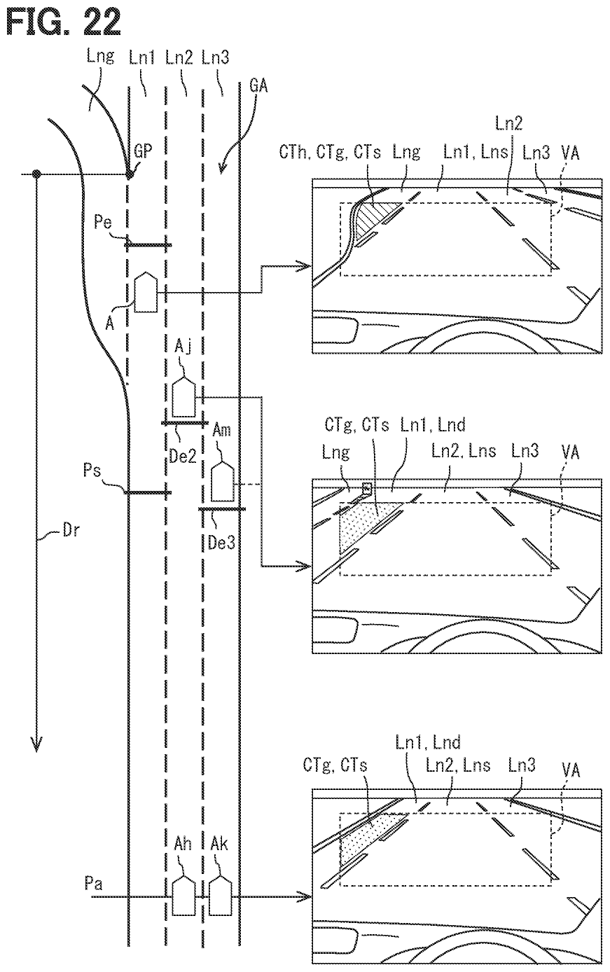

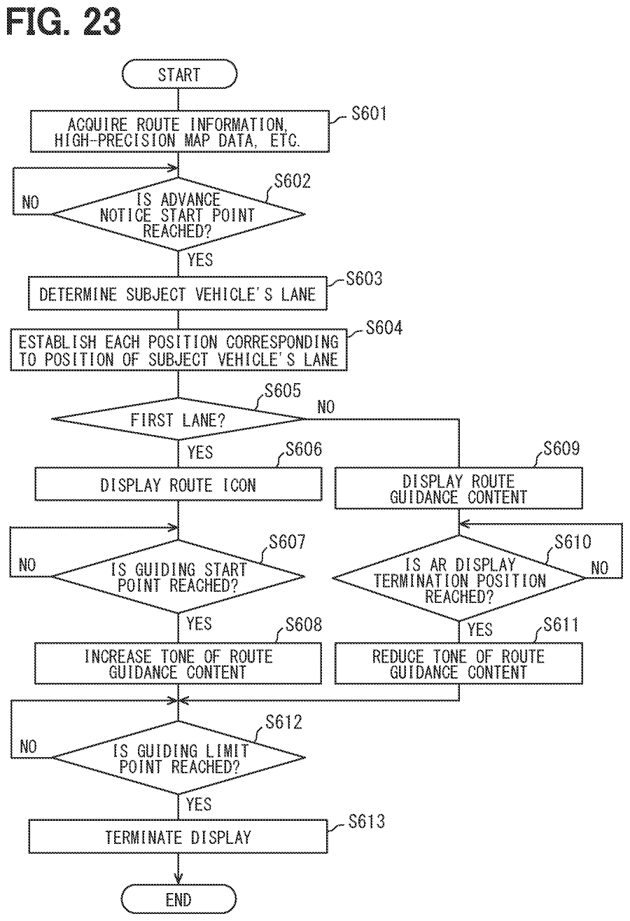

The sixth embodiment of the present disclosure shown in FIG. 22 and FIG. 23 is another modification to the fourth embodiment. A route guidance content CTg superimposed and displayed on a road surface in the sixth embodiment is increased or reduced in tone as the vehicle A approaches a reference point GP.

When the vehicle A is running in the first lane Ln1, the display generation unit 76 (Refer to FIG. 3) establishes an advance notice start point Pa, a guiding start point Ps, and a guiding limit point Pe. As in the fifth embodiment, the display generation unit 76 starts display of a route guidance icon CTi (Refer to FIG. 21) as a non-superimposed route guidance content CTg at the advance notice start point Pa.

The display generation unit 76 changes the content displayed as a route guidance content CTg from the route guidance icon CTi to a highlighted content CTh at the guiding start point Ps. The display generation unit 76 terminates the display of the highlighted content CTh at the guiding limit point Pe. When a destination of guidance lane Lng and the subject vehicle's lane Lns adjoin to each other, the highlighted content CTh superimposed and displayed on a road surface is increased in tone as the vehicle A approaches the guiding start point Ps. To increase the tone of the content, the display generation unit 76 causes at least either of a display variation to increase the lightness of display color of the highlighted content CTh or a display variation to increase a display brightness of the highlighted content CTh.

Meanwhile, when the vehicle A is running in the second lane Ln2 or the third lane Ln3, the display generation unit 76 establishes an advance notice start point Pa and an AR display termination position De2, De3. The display generation unit 76 superimposes and displays a route guidance content CTg on a road surface of an adjacent lane Lnd at the advance notice start point Pa (Refer to the vehicle Ah, Ak). When a destination of guidance lane Lng does not adjoin to the subject vehicle's lane Lns, the route guidance content CTg is reduced in tone as the vehicle A approaches the guiding start point Ps after passage by the AR display termination position De2, De3 (Refer to the vehicle Aj, Am). To reduce the tone of the content, the display generation unit 76 causes at least either of a display variation to reduce the lightness of display color of the highlighted content CTh or a display variation to reduce a display brightness of the highlighted content CTh.

Hereafter, a detailed description will be given to the display control method for providing route guidance display in the sixth embodiment based on a flowchart shown in FIG. 23. The processing of each step of S601 and S602 in the display control processing shown in FIG. 23 is substantially identical with the processing of each step of S101 and S102 (Refer to FIG. 8) in the first embodiment.

At S603, lane-specific information as positional information of the vehicle A is acquired and a position of the subject vehicle's lane Lns is determined based on the acquired lane-specific information. Then, the processing proceeds to S604. At S604, each position and each point corresponding to the position of the subject vehicle's lane Lns gasped at S603 are appropriately established and the processing proceeds to S605.

At S605, it is determined whether the position of the subject vehicle's lane Lns determined at S603 is in the first lane Ln1. When it is determined at S605 that the subject vehicle's lane Lns is the first lane Ln1, the processing proceeds to S606. At S607, a route guidance icon CTi is displayed and the processing proceeds to S607. At S607, the vehicle A's arrival at the guiding start point Ps is waited for and the processing proceeds to S608. At S608, a highlighted content CTh as a route guidance content CTg is displayed in place of the route guidance icon CTi. Further, increase in the tone of the highlighted content CTh is started and the processing proceeds to S612. The increase in the tone of the highlighted content CTh is caused based on locator information or an elapsed time.

Meanwhile, when it is determined at S605 that a position of the subject vehicle's lane Lns is not in the first lane Ln1, the processing proceeds to S609. At S609, superimposed display of a route guidance content CTg is started and the processing proceeds to S610. At S610, arrival at the AR display termination position De2, De3 is waited for. When it is determined at S610 that arrival at the AR display termination position De2, De3 has not been accomplished yet, the processing returns to S605. According to the foregoing, when movement to the first lane Ln1 is made before arrival at the AR display termination position De2, De3, the processing can proceed to S606 to S608.

Meanwhile, when it is determined at S610 that arrival at the AR display termination position De2, De3 has been accomplished, the processing proceeds to S611. At S611, reduction in the tone of the route guidance content CTg is started and the processing proceeds to S612. The reduction in the tone of the route guidance content CTg is also made based on locator information or an elapsed time. At S612, arrival at the guiding limit point Pe is waited for and the processing proceeds to S613. At S613, the display of the route guidance content CTg is terminated and the present display control processing is terminated.

In the sixth embodiment described up to this point, the tone of a route guidance content CTg is increased or reduced as a reference point GP comes closer. According to the foregoing, a route guidance content CTg not only provides route guidance but also can imply whether obedience to route guidance is recommended by variation in tone. As a result, content display easy for a driver to recognize is implemented.

In the sixth embodiment, in addition, when a destination of guidance lane Lng and the subject vehicle's lane Lns adjoin to each other, a route guidance content CTg is increased in tone. According to the foregoing, a driver can grasp that a lane change from the subject vehicle's lane Lns to a destination of guidance lane Lng is recommended, via display variation to gradually increase the tone of the route guidance content CTg.

In the sixth embodiment, further, when a destination of guidance lane Lng and the subject vehicle's lane Lns do not adjoin to each other, a route guidance content CTg is reduced in tone. According to the foregoing, a driver can grasp that a lane change from the subject vehicle's lane Lns to a destination of guidance lane Lng is not recommended, via display variation to gradually reduce the tone of a route guidance content CTg.

### Seventh Embodiment

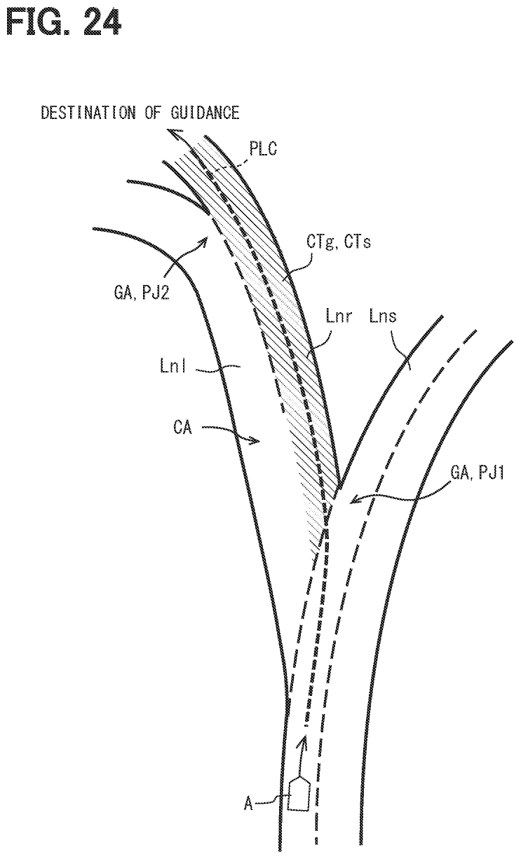

The seventh embodiment of the present disclosure is further another modification to the first embodiment. As shown in FIG. 24 to FIG. 26, route guidance display in the seventh embodiment is presented to a driver when a vehicle passes a plurality of guidance areas GA one after another. Hereafter, a detailed description will be given to route guidance display provided when a plurality of guidance areas GA are passed based on FIG. 24 to FIG. 26 with reference to FIG. 3.

When a first branch point PJ1 and a second branch point PJ2 as guidance areas GA are continuous, the route information acquisition unit 73 acquires route information including shape information of a lane change trajectory PLC continuously passing through these points. The display generation unit 76 grasps the presence of continuous branches based on route information acquired at the route information acquisition unit 73. At the first branch point PJ1 as the first guidance area GA, the display generation unit 76 displays a route guidance content CTg with route guidance at the second branch point PJ2 as the second guidance area GA taken into account.

The route guidance provides guidance for a lane change toward the left side upstream from the first branch point PJ1 and provides guidance for a lane change toward the right side upstream from the second branch point PJ2. If route guidance is provided at the first branch point PJ1 without taking into account route guidance at the second branch point PJ2, at the first branch point PJ1, the vehicle A would be guided to the left lane Ln1 of a road including two lanes after branching. Subsequently, the vehicle A would run in the left lane Ln1 for a while and be then provided with guidance for a lane change to the right lane Lnr upstream from the second branch point PJ2. In the above-mentioned route guidance, hindered by a parallel running car running in the right lane Lnr, a lane change from the left lane Ln1 to the right lane Lnr can become difficult.

To avoid an occurrence of such an event, route guidance at the first branch point PJ1 is so provided that the vehicle A can smoothly move to the right lane Lnr after branching. A connecting section CA connecting to a main lane roadway on a road ahead of a branch is provided with an area without a center line. The details of guidance in such a connecting section CA are different among route guidance respectively shown FIG. 24 to FIG. 26.

In route guidance shown in FIG. 24, a lane change trajectory PLC is generated in such a shape that the vehicle A is moved in substantially the shortest distance from the subject vehicle's lane Lns on a main lane roadway to the right lane Lnr as a destination of branching. A route guidance content CTg is extended with substantially the same superimposition width as the width of the vehicle A from the right portion of the border between the subject vehicle's lane Lns and the connecting section CA to the right lane Lnr, following this lane change trajectory PLC. In the connecting section CA, the route guidance content CTg is superimposed and displayed on the right half of the road surface.

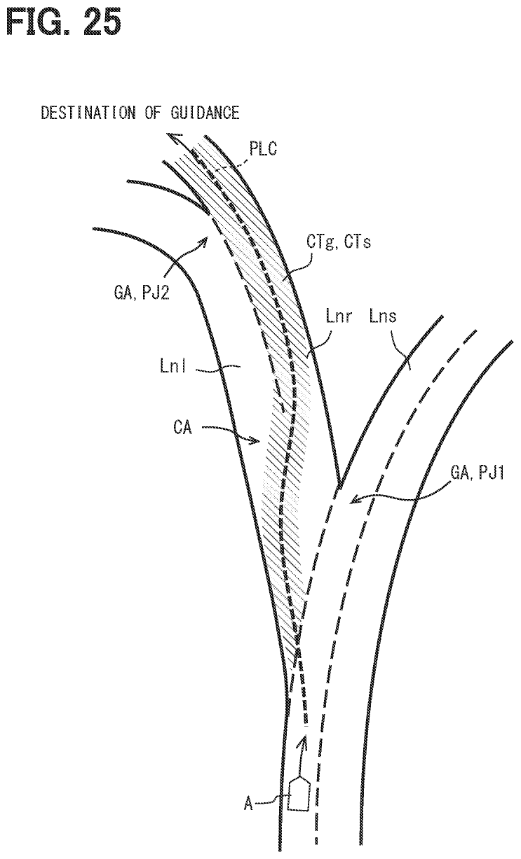

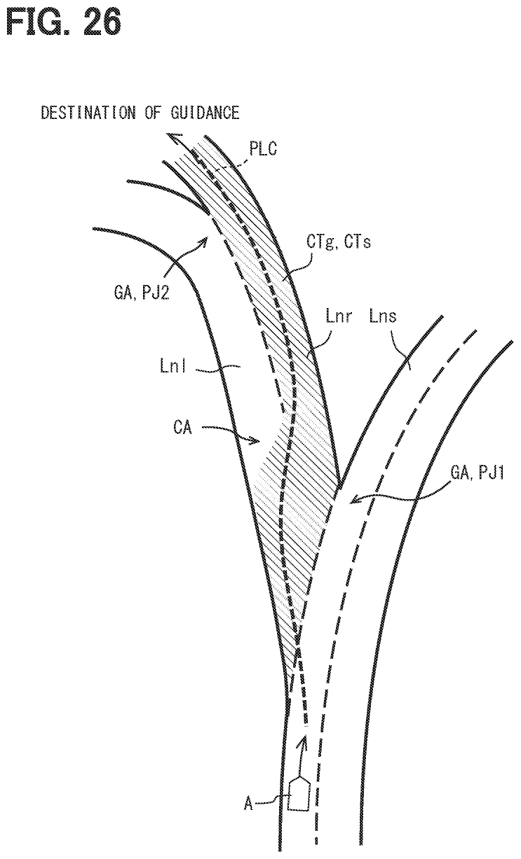

Meanwhile, in route guidance shown in FIG. 25 and FIG. 26, a lane change trajectory PLC is generated in such a shape that immediately after the vehicle A is once caused to make a lane change from the subject vehicle's lane Lns on a main lane roadway to the left side of a connecting section CA, movement to the right lane Lnr is further made without interruption. The route guidance content CTg shown in FIG. 25 traverses a connecting section CA from the left side to the right side and extends from the left portion of the border between the subject vehicle's lane Lns and the connecting section CA to the right lane Lnr with substantially the same superimposition width as the width of the vehicle A, following this lane change trajectory PLC. Further, the route guidance content CTg shown in FIG. 26 is increased in superimposition width in a connecting section CA. The route guidance content CTg is in such a superimposition shape that an entire road surface of the connecting section CA is filled.

In the seventh embodiment described up to this point, when a first branch point PJ1 and a subsequent second branch point PJ2 are continuous, a route guidance content CTg providing route guidance at the first branch point PJ1 is configured in a mode with route guidance at the second branch point PJ2 taken into account. According to the foregoing, the details of a route guidance content CTg displayed at a first branch point PJ1 can be matched with is an image of a behavior assumed by a driver intending to make continuous branching. Therefore, content display easy for a driver to recognize is implemented.

### Eighth Embodiment

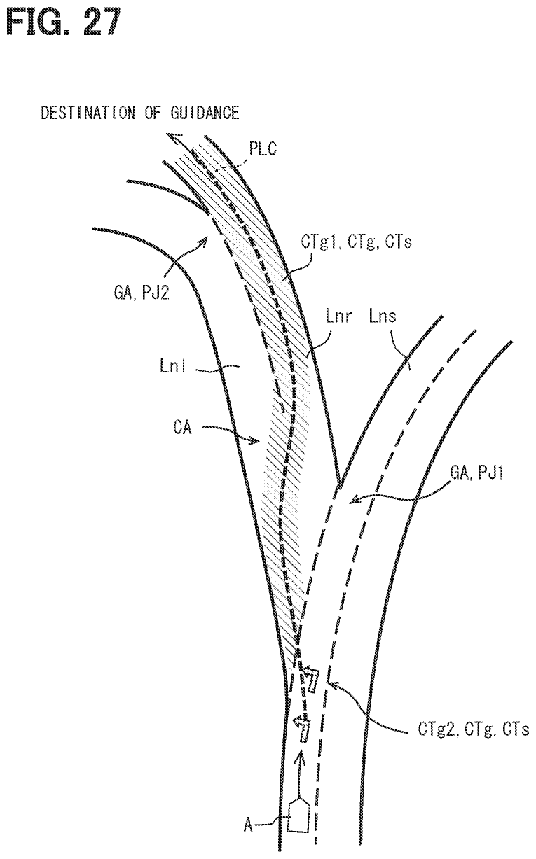

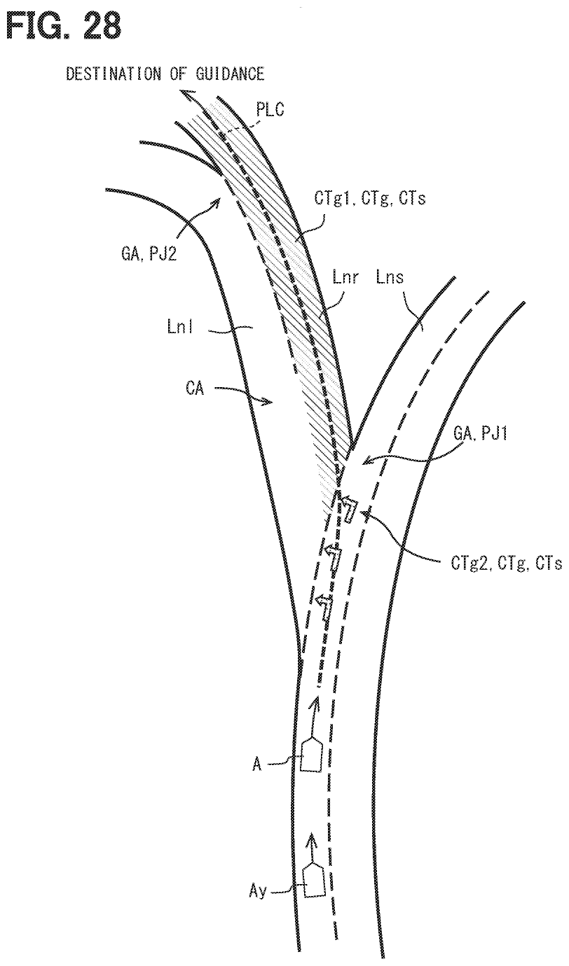

The eighth embodiment of the present disclosure is a modification to the seventh embodiment. As shown in FIG. 27 and FIG. 28, in route guidance display in the eighth embodiment, a first guidance content CTg1 and a second guidance content CTg2 are displayed as a route guidance content CTg. The first guidance content CTg1 is a superimposed content CTs substantially identical with a route guidance content CTg in the seventh embodiment (Refer to FIG. 24) and is displayed in a style corresponding to a lane change trajectory PLC. Specifically, the first guidance content CTg1 extends from the border between the subject vehicle's lane Lns and a connecting section CA to a right lane Lnr, following the lane change trajectory PLC. Meanwhile, the second guidance content CTg2 is superimposed and displayed on a road surface of the subject vehicle's lane Lns so that the content is visually recognized as a road paint in an arrow shape indicating a direction of the connecting section CA.

In the eighth embodiment, in addition, a shape of a lane change trajectory PLC is varied depending on the presence/absence of a rear vehicle Ay running behind the subject vehicle. According to the foregoing, a style of a first guidance content CTg1 indicating a lane change trajectory PLC is also varied depending on the presence/absence of a rear vehicle Ay.

A detailed description will be given. When a rear vehicle Ay is not following the subject vehicle, a lane change trajectory PLC is so shaped that immediately after the vehicle A is once caused to make a lane change from the subject vehicle's lane Lns on a main lane roadway to the left side of a connecting section CA, movement to a right lane Lnr is further made without interruption. For this purpose, the display generation unit 76 (Refer to FIG. 3) renders a first guidance content CTg1 in such a style that the content traverses the connecting section CA from the left area to the right area and extends to the right lane Lnr, following this lane change trajectory PLC. In addition, the display generation unit 76 superimposes and displays an arrow-shaped second guidance content CTg2 on a road surface located upstream from the left area so as to guide the subject vehicle to the left area of the connecting section CA.

Meanwhile, when a rear vehicle Ay is following the subject vehicle, a lane change trajectory PLC is so shaped that the vehicle A is moved in substantially the shortest distance from the subject vehicle's lane Lns on a main lane roadway to a right lane Lnr as a destination of branching. For this purpose, the display generation unit 76 renders a first guidance content CTg1 in such a style that the content extends from the right area of a connecting section CA to the right lane Lnr, following this lane change trajectory PLC. In addition, the display generation unit 76 superimposes and displays an arrow-shaped second guidance content CTg2 in a portion of a road surface of the subject vehicle's lane Lns facing to the connecting section so as to guide the subject vehicle to the right area of the connecting section CA.

Also, in the eighth embodiment described up to this point, the same effects as in the seventh embodiment are brought about and provision of route guidance display whose details are matched with an image of a behavior assumed by a driver intending to make continuous branching is facilitated. Therefore, content display easy for a driver to recognize is implemented.

In the eighth embodiment, in addition, a shape of a lane change trajectory PLC and by extension a style of a first guidance content CTg1 are varied depending of the presence/absence of a rear vehicle Ay. As a result, when a rear vehicle Ay is not present, a driver can make a lane change stepwise in obedience to route guidance display. Meanwhile, when a rear vehicle Ay is present, direct left-hand branching is recommended. As a result, a risk of a lane change to a right lane Lnr being hindered by a rear vehicle Ay can be reduced.

In the eighth embodiment, a first guidance content CTg1 is equivalent to “acquired route content,” and a second guidance content CTg2 is equivalent to “route guidance content.”

<Modifications 11 to 14>

In Modification 11 to the seventh and eighth embodiments, a route guidance content CTg or a first guidance content CTg1 is superimposed on not only a road surface on the second branch point PJ2 side of a connecting section CA but also a road surface of the subject vehicle's lane Lns and indicates a shape of a lane change trajectory PLC. Such a route guidance content CTg or a first guidance content CTg1 may be in a single line configuration superimposed on the center of a lane along a lane change trajectory PLC or may be in two-line configuration superimposed on both sides of a lane along a lane change trajectory PLC.

In Modification 12 to the seventh embodiment, the display generation unit 76 calculates a distance between a first branch point PJ1 and a second branch point PJ2 (hereafter, referred to as “continuation distance”) based on route information. The display generation unit 76 compares the continuation distance with a predetermined spacing threshold value. The spacing threshold value is a threshold value for determining how far two guidance areas GA are distant from each other. When the continuation distance exceeds the spacing threshold value, the display generation unit 76 determines that the first branch point PJ1 and the second branch point PJ2 are relatively distant from each other. In this case, as shown in FIG. 25, the display generation unit 76 provides route guidance for making a lane change to the left side of a connecting section CA at the first branch point PJ1. After the vehicle A runs in the left lane Ln1 for a while, the display generation unit 76 provides route guidance prompting a lane change to the right lane Lnr.

Meanwhile, when the continuation distance is less than the spacing threshold value, the display generation unit 76 determines that the first branch point PJ1 and the second branch point PJ2 are in proximity to each other. In this case, as shown in FIG. 24, the display generation unit 76 provides route guidance for making a lane change to the right portion of the connecting section CA at the first branch point PJ1.

By varying route guidance at a first branch point PJ1 in accordance with a spacing distance between the first branch point PJ1 and a second branch point PJ2 as in Modification 12 mentioned above, route guidance more understandable for a driver is implemented.

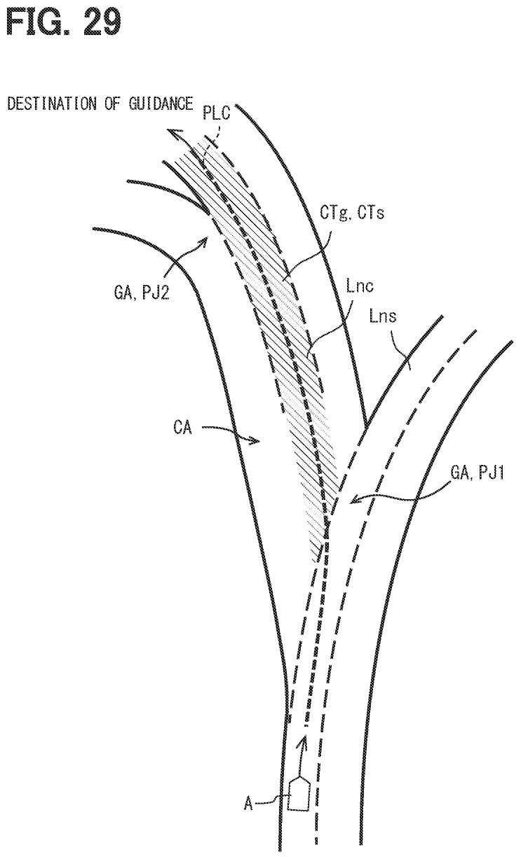

In Modification 13 to the seventh embodiment, as shown in FIG. 29, a road as a destination of branching is constituted of three lanes. Also, with respect to such a road, a route guidance content CTg is superimposed and displayed on a road surface of the road as a destination of branching in a superimposition shape tracing a lane change trajectory PLC so that the vehicle A smoothly moves from the subject vehicle's lane Lns to the central lane Lnc.

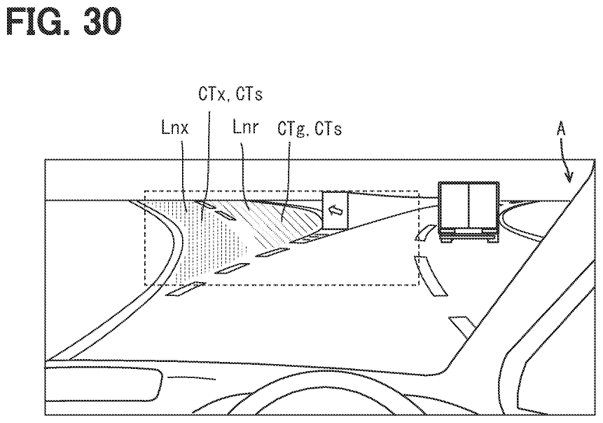

In Modification 14 to the seventh embodiment, as shown in FIG. 30, in addition to a route guidance content CTg, a movement limit content CTx is superimposed and displayed on a road surface of a road as a destination of movement. The route guidance content CTg is superimposed and displayed on a road surface of the right lane Lnr leading to a destination of guidance. The route guidance content CTg is displayed in blue, green, or the like. Meanwhile, the movement limit content CTx is superimposed and displayed on a road surface Lnx within a range excluding the right lane Lnr to notify a driver that a movement to the range of the road surface Lnx should not be made. The movement limit content CTx is displayed in a display color different from that of the route guidance content CTg, specifically, in such a warning color as yellow, umber, or the like.

In cases where a route guidance content CTg is superimposed and displayed on a road surface of a road as a destination of branching as in Modification 14 mentioned above, a superimposition area of the route guidance content CTg can become difficult to recognize when the road as a destination of branching is far away from the vehicle A. A specific description will be given. For example, when a road as a destination of branching is horizontally extended from a main lane in the foreground, a route guidance content CTg is brought into a shape of a narrow line horizontally extended as well. By only such a route guidance content CTg, it is difficult to make a driver grasp a lane as a destination of movement.

When displayed together with a route guidance content CTg, a movement limit content CTx makes a lane as a destination of movement easy for a driver to grasp on a road as a destination of branching even when the road as a destination of branching is far from the vehicle A. For example, when a movement limit content CTx is displayed on this side (lower part) of a route guidance content CTg, a driver can grasp that a lane on the far side is a destination of movement.

### Other Embodiments

Up to this point, a description has been given to a plurality of embodiments of the present disclosure and modifications to the embodiments. The present disclosure should not be interpreted as being limited to the above embodiments or modifications and is applicable to various embodiments and combinations without departing from the subject matter of the present disclosure.

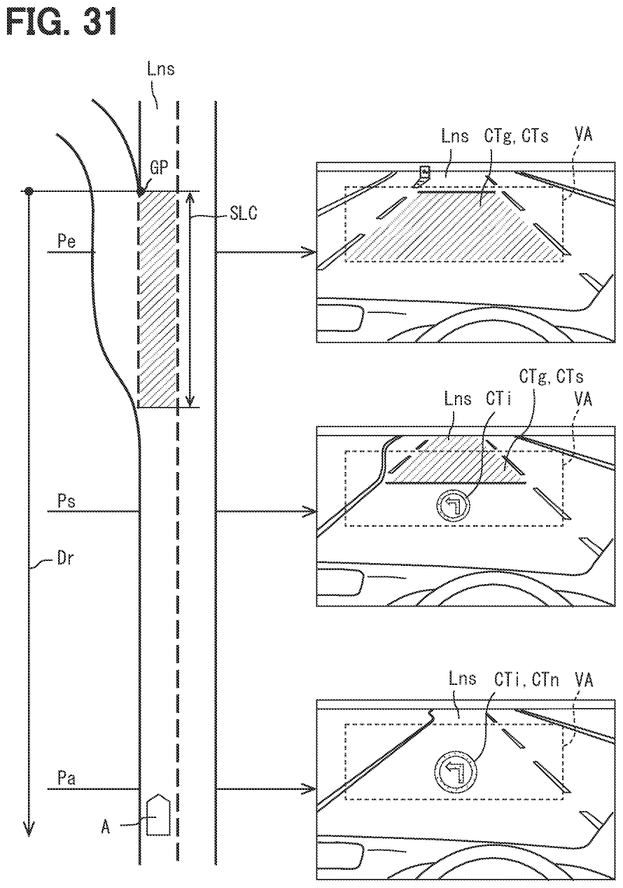

In route guidance display in Modification 15 to the above embodiments, as shown in FIG. 31, a route guidance content CTg is displayed as a superimposed content CTs indicating a range within which a lane change is possible in correspondence with a driver being unknowing of timing of a lane change. The route guidance content CTg is superimposed and displayed in a lane change section SLC in which a lane change is possible on a road surface of the subject vehicle's lane Lns. An end of a lane change section SLC in which a lane change is possible is established in a position aligned with a reference point GP as in each of the above embodiments. An end of a lane change section SLC is established slightly upstream from a reference point GP.

The display generation unit 76 starts display of a route guidance content CTg together with a route guidance icon CTi at a guiding start point Ps. The route guidance content CTg is superimposed and displayed in a traveling direction of the route guidance icon CTi. The display of the route guidance icon CTi is terminated when the route guidance content CTg moves to this side (downward). The display generation unit 76 continues the display of the route guidance content CTg until the route guidance content CTg exits a view angle VA or the vehicle A arrives at a guiding limit point Pe.

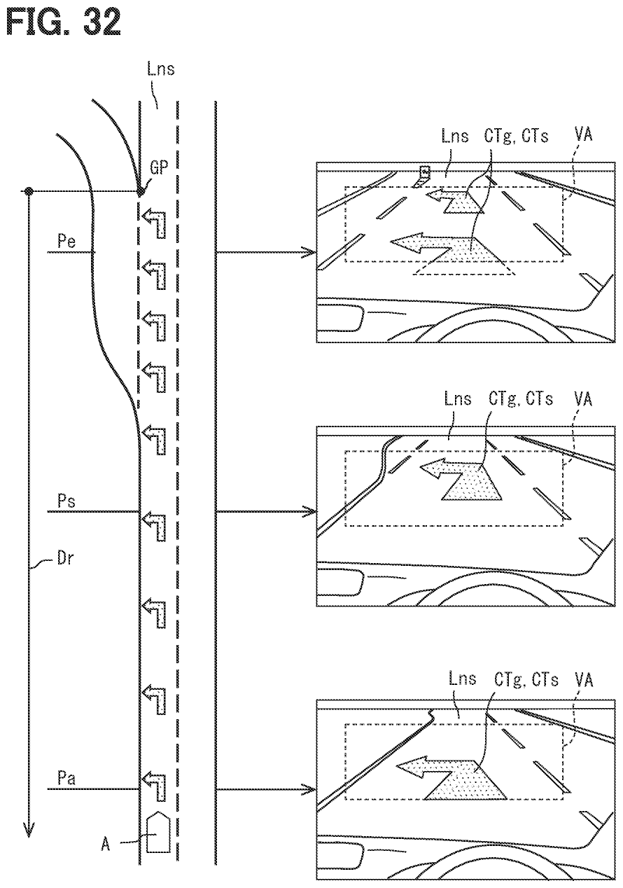

In route guidance display in Modification 16 to the above embodiments, as shown in FIG. 32, a large number of route guidance contents CTg AR-displaying an arrow-shaped road paint are used. The route guidance contents CTg are superimposed and displayed on a road surface of the subject vehicle's lane Lns and move toward the subject vehicle side in the foreground together with the road surface. The route guidance contents CTg repeatedly come to within a view angle VA and exit the view angle VA from the time of the vehicle A's arrival at an advance notice start point Pa to the time of arrival at a guiding limit point Pe. The route guidance contents CTg may be arranged at equal intervals or the spacing therebetween may be narrowed with proximity to a reference point GP.

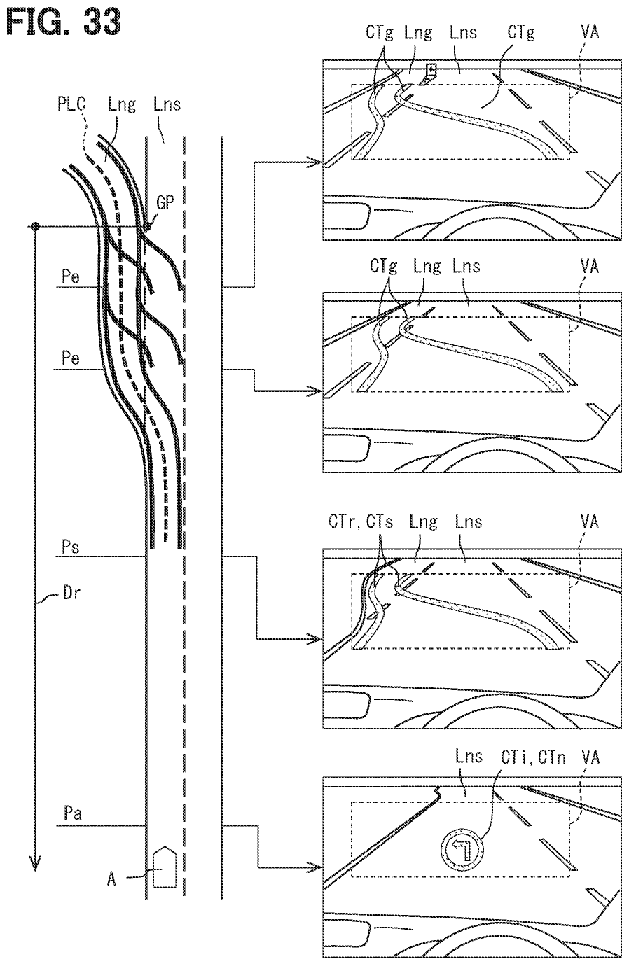

In route guidance display in Modification 17 to the above embodiments, as shown in FIG. 33, recalculation of an ideal lane change trajectory PLC is repeated at at least one of the route generation server, the locator ECU 44, and the driving assist ECU 50. The display generation unit 76 successively acquires shape information of the recalculated lane change trajectory PLC and updates a shape of a route guidance content CTg based on the newest lane change trajectory PLC. The display generation unit 76 continues to update the route guidance content CTg until the vehicle A arrives at a guiding limit point Pe after the vehicle A's arrival at a guiding start point Ps.

When updating of a route guidance content CTg is repeated as in Modification 17, a display blur can be caused in the route guidance content CTg by the virtual image display system 10a. To avoid an occurrence of such a display blur, in Modification 18, updating of a route guidance content CTg is discontinued with specific timing. An example will be taken. The display generation unit 76 stores a route guidance content CTg as a template when the vehicle A arrives at a guiding start point Ps and continues to display the templated route guidance content CTg. In Modification 18 mentioned above, a fluctuation in display of a route guidance content CTg is reduced by permitting a superimposition deviation of a route guidance content CTg relative to the subject vehicle's lane Lns and a destination of guidance lane Lng.

In Modification 19, the timing of discontinuing updating of a route guidance content CTg is different from that in Modification 18. In Modification 19, the display generation unit 76 discontinues updating of a shape of a route guidance content CTg when a lane change is started. The display generation unit 76 fixes a shape of the route guidance content CTg when the center of the vehicle A moves to a destination of guidance lane Lng, when a turn signal lamp is turned on, when steering operation for a lane change is imputed, or on other like occasions. In this case, the route guidance content CTg horizontally moves within a view angle VA following a road surface in the foreground in conjunction with traversing of the vehicle A.

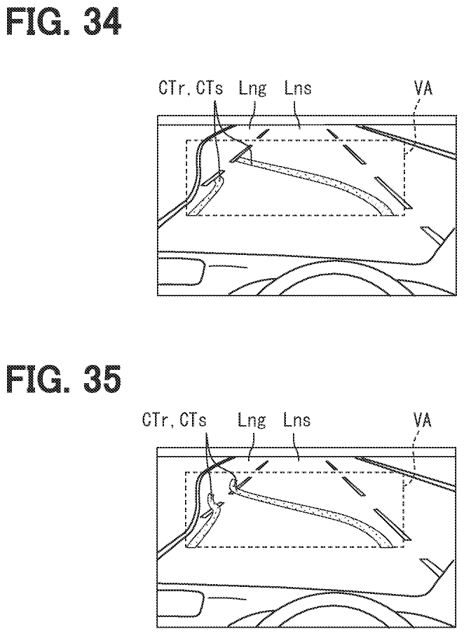

As in Modification 20 shown in FIG. 34, the frontward-side tip portion of a route guidance content CTg may remain in the subject vehicle's lane Lns without extending to a road surface of a destination of guidance lane Lng. As in Modification 21 shown in FIG. 35, in addition, the frontward-side tip portion of a route guidance content CTg may be slightly superimposed on a road surface of a destination of guidance lane Lng and stay in proximity to the subject vehicle's lane Lns. By limiting superimposition on a destination of guidance lane Lng as in Modifications 20, 21, a display deviation of a route guidance content CTg relative to a destination of guidance lane Lng becomes less prone to be recognized by a driver.

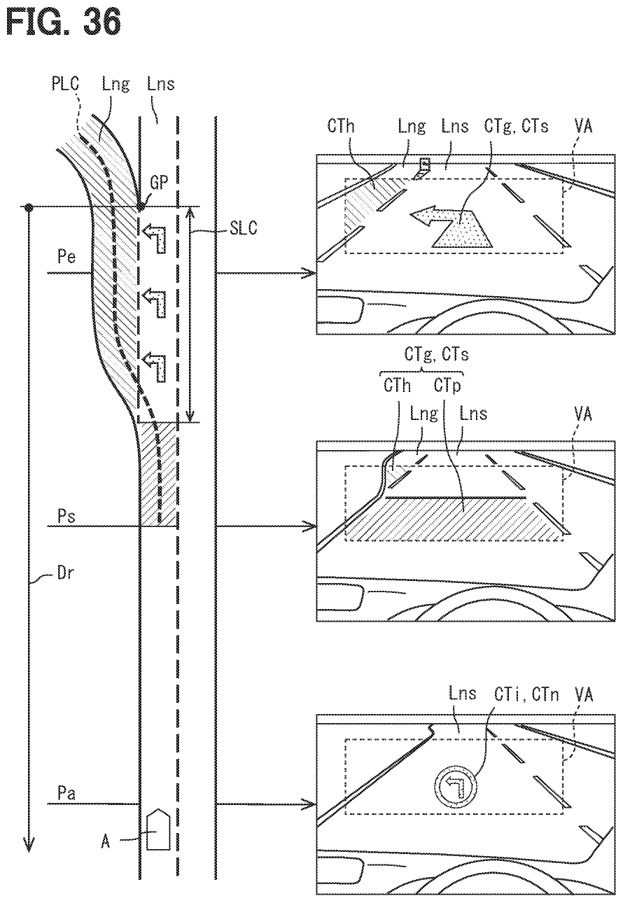

In route guidance display in Modification 22 to the above embodiments, as shown in FIG. 36, a route guidance content CTg displayed at a guiding start point Ps contains a highlighted content CTh and a guidance advance notice content CTp. The highlighted content CTh is a superimposed content CTs that is superimposed on a road surface of a destination of guidance lane Lng as a destination of movement in a lane change to highlight the destination of guidance lane Lng. The guidance advance notice content CTp is a superimposed content CTs that is superimposed on this side of a lane change section SLC in which a lane change is possible on a road surface of the subject vehicle's lane Lns. Even when the subject vehicle's lane Lns does not adjoin to a destination of guidance lane Lng, a guidance advance notice content CTp is superimposed and displayed on a road surface of the subject vehicle's lane Lns. When this guidance advance notice content CTp moves out of a view angle VA, an arrow-shaped route guidance content CTg is displayed. Display of the route guidance content CTg may be omitted.

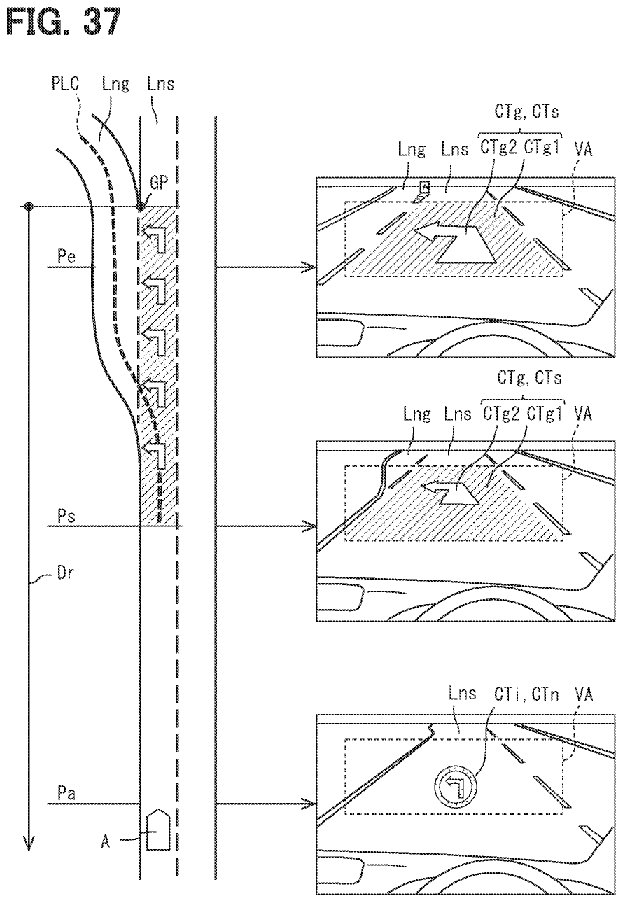

In route guidance display in Modification 23 to the above embodiments, as shown in FIG. 37, a first guidance content CTg1 and a second guidance content CTg2 are displayed as a route guidance content CTg. The first guidance content CTg1 is superimposed in a section of a road surface of the subject vehicle's lane Lns ranging from a guiding start point Ps to a reference point GP and is displayed in such a manner that the section is filled. The second guidance content CTg2 is displayed superimposed on the first guidance content CTg1. A plurality of second guidance contents CTg2 are arranged on the first guidance content CTg1. The second guidance content CTg2 is a superimposed content CTs AR-displaying an arrow-shaped road paint on a road surface and is displayed as an animation flowing in a direction of a destination of guidance lane Lng.

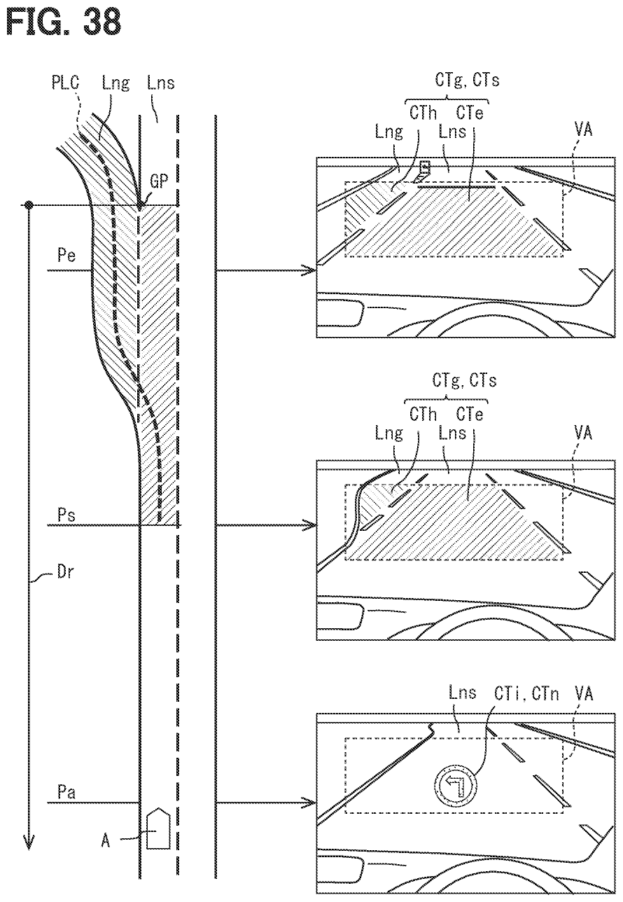

In route guidance display in Modification 24 to the above embodiments, as shown in FIG. 38, a highlighted content CTh and an area guidance content CTe are displayed as a route guidance content CTg. The highlighted content CTh is superimposed and displayed on a road surface of a destination of guidance lane Lng. The area guidance content CTe is superimposed and displayed in a section of a road surface of the subject vehicle's lane Lns ranging from a guiding start point Ps to a reference point GP and indicates an area where a lane change is possible. A highlighted content CTh and an area guidance content CTe are displayed in different display colors from each other so that a driver can easily discriminate. A highlighted content CTh is displayed in a mode with a higher conspicuity than that of an area guidance content CTe.

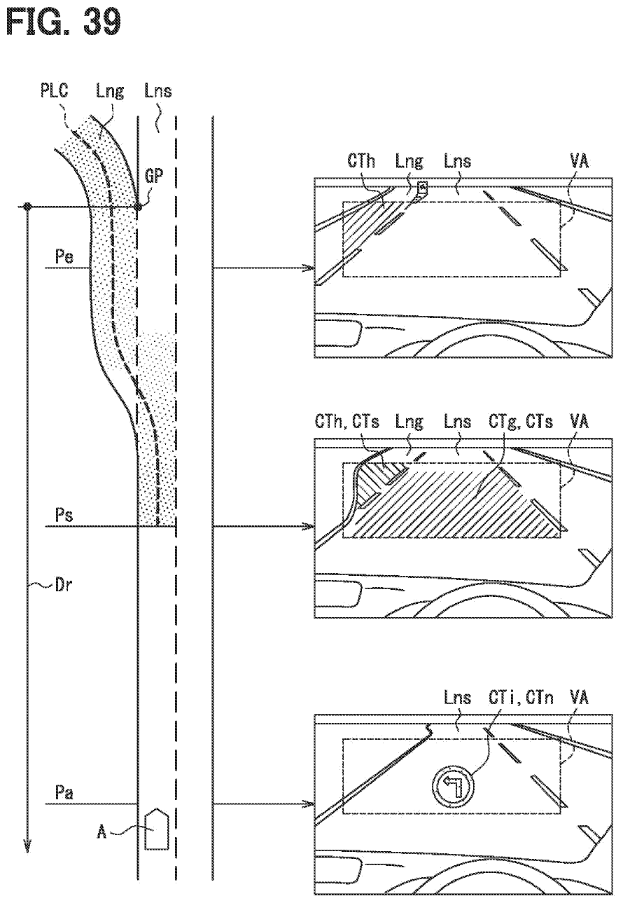

In route guidance display in Modification 25 to the above embodiments, as shown in FIG. 39, a highlighted content CTh and an area guidance content CTe are displayed as a route guidance content CTg. The highlighted content CTh is superimposed and displayed on a road surface of a destination of guidance lane Lng. The highlighted content CTh is gradated so that the highlighted content becomes lighter as it goes toward this side. The area guidance content CTe is displayed on a road surface of the subject vehicle's lane Lns farther than a guiding start point Ps in a traveling direction. The area guidance content CTe is gradated so that the area guidance content becomes lighter as it goes farther in the traveling direction. Since the highlighted content CTh and the area guidance content CTe are displayed with gradation in opposite directions to each other, the display can be made less conspicuous in an intermediate section where a judgment is referred to a user.

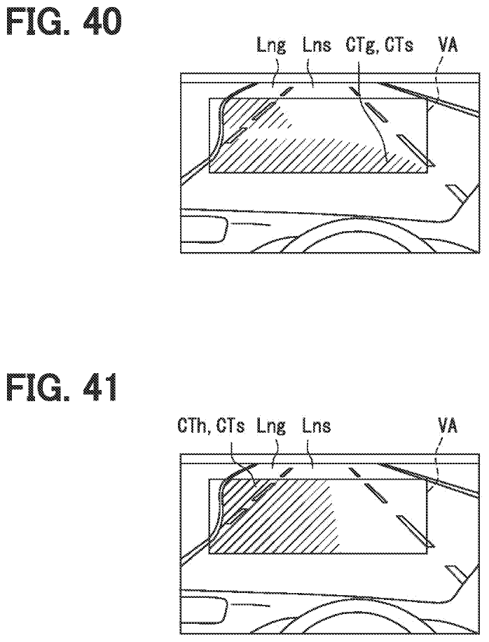

A direction in which the route guidance content CTg is gradated may be slanted relative to a traveling direction as in Modification 26 shown in FIG. 40. Owing to the gradation in a slanting direction, the vicinity of each of the upper edge and lower edge of the route guidance content CTg in Modification 26 is darkly displayed and the intermediate portion of the content is lightly displayed.

A direction in which the route guidance content CTg is gradated may be lateral as in Modification 27 shown in FIG. 41. In the route guidance content CTg in Modification 27, a portion superimposed on a road surface of a destination of guidance lane Lng is most darkly displayed. Meanwhile, a portion of the route guidance content CTg superimposed on a road surface of the subject vehicle's lane Lns is more lightly displayed as it is laterally brought away from the destination of guidance lane Lng.

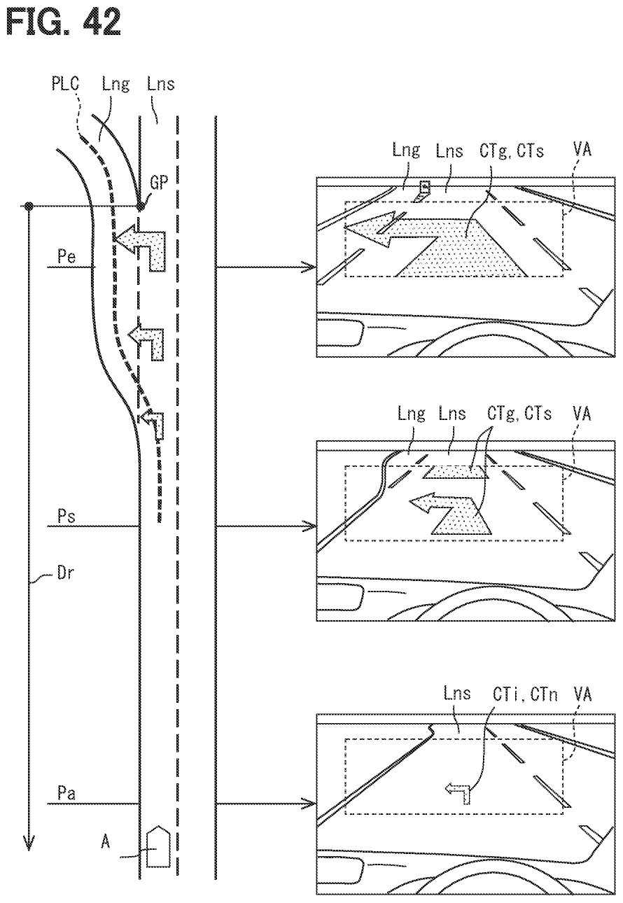

In route guidance display in Modification 28 to the above embodiments, as shown in FIG. 42, a large number of route guidance contents CTg AR-displaying an arrow-shaped road paint are superimposed on a road surface in a traveling direction. A size of each route guidance content CTg is gradually increased as it is brought closer to a guiding limit point Pe and a reference point GP. According to the foregoing, guiding for a lane change to a destination of guidance lane Lng is more highlighted as it is brought closer to a guiding limit point Pe. The first route guidance content CTg positioned on the most upstream side is superimposed and displayed only on a road surface of the subject vehicle's lane Lns. Conversely, the last route guidance content CTg positioned farthest in a traveling direction is superimposed and displayed astride respective road surfaces of the subject vehicle's lane Lns and the destination of guidance lane Lng.

A size of each route guidance content CTg may be gradually reduced. A display brightness of each route guidance content CTg may be gradually reduced or increased in accordance with variation in size.

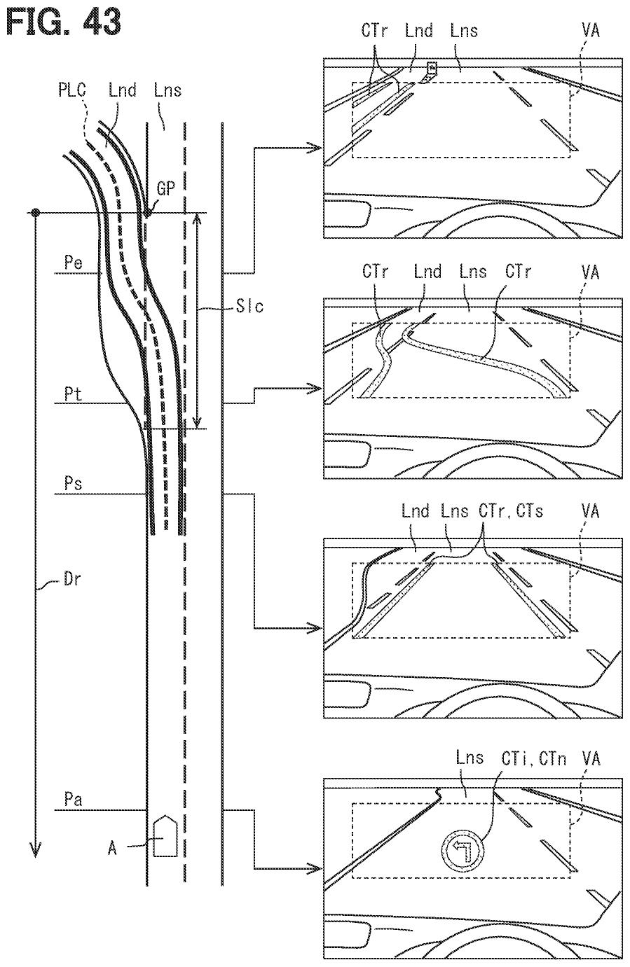

In Modification 29 to the above embodiments, as shown in FIG. 43, a lane change trajectory PLC in such a shape as to move from the subject vehicle's lane Lns to an adjacent lane Lnd is generated at some midpoint in a lane change section SLC where a lane change is possible. Therefore, an ideal route content CTr is rendered in a shape extending along the lane change trajectory PLC so as to show such a shape of the lane change trajectory PLC in the foreground.

With respect to each content in the above embodiments, statistic elements, such as display color, display brightness, a display shape as a basis, and the like and dynamic elements, such as the presence/absence of flashing, a cycle of flashing, the presence/absence of animation, action in animation, and like may be appropriately varied. The statistic or dynamic elements of each content may be varied according to a driver's taste. The running scenes showing exemplary route guidance display in the descriptions of the above embodiments and the modifications to the embodiments are just an example. Even at a running scene different from the foregoing, the HCU is capable of implementing route guidance display in which a non-superimposed content and a superimposed content are used together.

The HCU in the above embodiments successively controls a projection shape and a projection position of virtual image light formed into an image as a superimposed content CTs using positional information of an eye point EP detected by the DSM so that a superimposed content is superimposed on a superimposition target without deviation as viewed from a driver. Meanwhile, the HCU in Modification 30 to the above embodiments controls a projection shape and a projection position of virtual image light formed into an image as a superimposed content using set information of a preset reference eye point center without use of detection information from the DSM.

The projector 21 of the HUD 20 in Modification 31 is provided with an EL (Electro Luminescence) panel in place of an LCD panel and a backlight. Further, a projector using such a display as a plasma display panel, CRT, LED, or the like in place of an EL panel can be adopted for the HUD 20.

The HUD 20 in Modification 32 is provided with a laser module (hereafter, referred to as “LSM”) and a screen in place of LCD and a backlight. The LSM is configured to include, for example, a laser light source, a MEMS (Micro Electro Mechanical Systems) scanner, and the like. The screen is, for example, a micromirror array or a micro lens array. In such an HUD 20, a display image is rendered on the screen by scanning laser light projected from the LSM. The HUD 20 projects a display image rendered on the screen onto a windshield by a magnifying optical element, thereby displaying a virtual image Vi in midair.

The HUD 20 in Modification 33 is provided with a DLP (Digital Light Processing, registered trademark) projector. The DLP projector includes a digital mirror device (hereafter, referred to as “DMD”) provided with a large number of micro-mirrors and a projection light source projecting light toward the DMD. The DLP projector renders a display image on a screen via control with cooperation between the DMD and the projection light source.

The HUD 20 in Modification 34 adopts a projector using LCOS (Liquid Crystal On Silicon).

The HUD 20 in Modification 35 adopts a holographic optical element in one of optical systems for displaying a virtual image Vi in midair.

In Modification 36 to the above embodiments, the HCU and the HUD are integrally configured. That is, the processing functionality of the HCU is implemented in a control circuit of the HUD. In Modification 36, the HUD is equivalent to a virtual image display system in the first embodiment. The processing functionality of the HCU may be implemented in a control circuit of the navigation ECU.

In Modification 37 to the above embodiments, the HCU 100 is provided with a camera image acquisition unit that acquires imaging data from the front camera 31 obtained by picking up an image of the foreground of the subject vehicle. The display generation unit 76 generates picture data obtained by overlaying such an original image as an ideal route content CTr, a route guidance content CTg, a highlighted content CTh, a route guidance icon CTi, or the like on a real image of the foreground based on the imaging data. Based on such picture data, the HUD 20 projects display in which each content and icon are overlaid on a real image onto the foreground as a virtual image. When a view angle VA of the HUD 20 is insufficient as mentioned above, virtual image display in which such an original image as a content or the like used in AR display is overlaid on a real image may be provided at a scene where an AR content is out of a view angle VA or other like scenes.

In the above embodiments, the subject vehicle's lane Lns is located by the driving assist ECU 50. However, a functionality of locating the subject vehicle's lane Lns may be provided in the locator ECU 44 as in Modification 38 to the above embodiments. In Modification 38, the locator ECU 44 locates the subject vehicle's lane Lns by combining locator information with high-precision map data. The locator ECU 44 provides generated lane-specific information to the locator information acquisition unit 72 together with locator information.

In Modification 39 to the above embodiments, route guidance by a meter display is controlled in cooperation with the navigation display 56 of the navigation device 55. Therefore, in Modification 39, route guidance by virtual image display is terminated prior to route guidance by the navigation display 56 and the meter display.

Each functionality provided by the HCU in the above embodiments can also be provided by software and hardware executing the software, software only, hardware only, or a composite combination of these elements. When such a functionality is provided by an electronic circuit as hardware, the functionality can also be provided by a digital circuit or an analog circuit including a large number of logic circuits.

A form of a storage medium storing a program or the like capable of implementing the above-mentioned display control method may also be appropriately modified. For example, a storage medium is not limited to a configuration provided on a circuit board but may be configured to be provided in the form of a memory card or the like, inserted into a slot, and electrically connected to a control circuit of the HCU. Further, a storage medium may be an optical disk, a hard disk drive, or the like as a source of a program copied to the HCU.

A vehicle mounted with the HMI system is not limited to an ordinary passenger car for private use and may be a vehicle for rental, a vehicle for manned taxi, a vehicle for ride sharing, a cargo vehicle, a bus, or the like. Further, a driverless vehicle used for mobility service may be mounted with the HMI system including the HCU.

A vehicle mounted with the HMI system may be a right-hand drive vehicle or may be a left-hand drive vehicle. A traffic environment in which the relevant vehicle runs may be a traffic environment based on left-hand traffic or may be a traffic environment based on right-hand traffic. Each content display for driving assist according to the present disclosure is appropriately optimized according to a Road Traffic Law in individual countries and regions as well as the position of the steering wheel of the relevant vehicle and the like.

A control unit described in the present disclosure and a technique for the control unit may be implemented by a dedicated computer provided by configuring a processor and a memory programmed to perform one or more functions made concrete by a computer program. Or, a control unit described in the present disclosure and a technique for the control unit may be Implemented by a dedicated computer provided by configuring a processor with one or more dedicated hardware logic circuits. Alternatively, a control unit described in the present disclosure and a technique for the control unit may be implemented by one or more dedicated computers configured by combining a processor and a memory programmed to perform one or more functions with a processor constituted of one or more hardware logic circuits. A computer program may be stored in a computer-readable non-transitional tangible recording medium as an instruction executed by a computer.

The flowcharts described in the present application or the processing of the flowcharts is constituted of a plurality of sections (also referred to as steps) and each section is expressed as, for example, S10. Each section can be divided into a plurality of subsections. Meanwhile, a plurality of sections can be combined into one section. Each of the thus configured sections can be referred to as device, module, or means.

The present disclosure has been described in accordance with embodiments but it is understood that the present disclosure is not limited to these embodiments or structures. The present disclosure includes various modifications and modifications within an equivalent range. In addition, various combinations and forms and other combinations and forms obtained by including more than one, only one, or less than one element in those combinations and forms also fall within the category and scope of the present disclosure.

The controllers and methods described in the present disclosure may be implemented by a special purpose computer created by configuring a memory and a processor programmed to execute one or more particular functions embodied in computer programs. Alternatively, the controllers and methods described in the present disclosure may be implemented by a special purpose computer created by configuring a processor provided by one or more special purpose hardware logic circuits. Alternatively, the controllers and methods described in the present disclosure may be implemented by one or more special purpose computers created by configuring a combination of a memory and a processor programmed to execute one or more particular functions and a processor provided by one or more hardware logic circuits. The computer programs may be stored, as instructions being executed by a computer, in a tangible non-transitory computer-readable medium.

It is noted that a flowchart or the processing of the flowchart in the present application includes sections (also referred to as steps), each of which is represented, for instance, as S101. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A display control device for a vehicle controlling a display of a head-up display, the display control device comprising:
a route information acquisition unit acquiring route information of the vehicle when route guidance is executed for a driver who drives the vehicle; and
a display control unit superimposing and displaying an acquired route content indicating a shape of a lane change trajectory in a foreground of the vehicle based on the route information on a road surface, and superimposing and displaying a route guidance content executing the route guidance for prompting the driver to change a traffic lane at a position deviated from the lane change trajectory in the foreground.

2. The display control device according to claim 1, wherein:
when the acquired route content is disposed out of a view angle of the head-up display, the display control unit superimposes and displays the route guidance content.

3. The display control device according to claim 1, wherein:
when a front part of the acquired route content superimposed on a traffic lane of the vehicle deviates from a view angle of the head-up display, the display control unit starts superimposing and displaying the route guidance content.

4. The display control device according to claim 1, wherein:
the display control unit determines at least one of whether an other vehicle exists ahead of the vehicle and whether the other vehicle visually recognized within a view angle of the head-up display exists;
when determining that the other vehicle does not exist, the display control unit superimposes and displays the acquired route content; and
when determining that the other vehicle exists, the display control unit superimposes and displays a highlighted content for highlighting a destination of guidance on a road surface based on the route information.

5. The display control device according to claim 1, wherein:
when a lane change section is disposed within a view angle of the head-up display and further driver input related to a lane change is present, the display control unit displays the acquired route content in a different mode from when the lane change section is out of the view angle or when the driver input is not present.

6. The display control device according to claim 1, wherein:
when a lane change of the vehicle is a lane change for merging into a main road, the display control unit restricts the display of either the acquired route content or the route guidance content.

7. The display control device according to claim 1, wherein:
the display control unit determines a degree of overlapping between a road surface of a destination of movement in a lane change and a view angle of the head-up display; and
when the degree of overlapping is less than an overlapping threshold value, the display control unit displays an additional information content for guiding a lane change in addition to the acquired route content.

8. A display control device for a vehicle controlling a display of a head-up display, the display control device comprising:
a positional information acquisition unit acquiring positional information of the vehicle;
a route information acquisition unit acquiring route information of the vehicle in a guidance area where route guidance is to be executed for a driver who drives the vehicle; and
a display control unit that changes a display control of a route guidance content for the route guidance for prompting the driver to change a traffic lane according to a position of a traffic lane of the vehicle indicated by the positional information when the route guidance is executed in the guidance area of a road including a plurality of traffic lanes.

9. The display control device according to claim 8, wherein:
the display control unit superimposes and displays a highlighted content for highlighting a destination of guidance as the route guidance content in a case where a destination of guidance lane as the destination of guidance is adjacent to a traffic lane of the vehicle in the guidance area even when a remaining distance from the vehicle to the guidance area is less than a termination threshold value; and
the display control unit does not superimpose and display the highlighted content in a case where the destination of guidance lane is not adjacent to the traffic lane of the vehicle when the remaining distance is less than the termination threshold value.

10. The display control device according to claim 9, wherein:
the display control unit superimposes and displays the highlighted content even in a case where the destination of guidance lane is not adjacent to the traffic lane of the vehicle when the remaining distance exceeds the termination threshold value.

11. The display control device according to claim 8, wherein:
the display control unit superimposes and displays a highlighted content for highlighting a destination of guidance as the route guidance content when a destination of guidance lane as the destination of guidance is adjacent to the traffic lane of the vehicle in the guidance area; and
the display control unit displays the route guidance content in a different form from the highlighted content when the destination of guidance lane is not adjacent to the traffic lane of the vehicle.

12. The display control device according to claim 11, wherein:
the display control unit displays non-superimposed route guidance content when a remaining distance from the vehicle to the guidance area is less than a termination threshold value in a case where the destination of guidance lane is not adjacent to the traffic lane of the vehicle; and
the display control unit superimposes and displays the highlighted content when the remaining distance exceeds the termination threshold value in a case where the destination of guidance lane is not adjacent to the traffic lane of the vehicle.

13. The display control device according to claim 11, wherein:
the display control unit executes an additional notification related to a movement to the destination of guidance lane when the destination of guidance lane is not adjacent to the traffic lane of the vehicle.

14. The display control device according to claim 8, wherein:
the display control unit further displays an end notification content indicating a distance to an end of a lane change section in the guidance area.

15. A display control device for a vehicle controlling a display of a head-up display, the display control device comprising:
a positional information acquisition unit acquiring positional information of the vehicle;
a route information acquisition unit acquiring route information of the vehicle in a guidance area where route guidance is to be executed for a driver who drives the vehicle; and
a display control unit that executes the route guidance in the guidance area using a route guidance content superimposed and displayed on a road surface, and increases or reduces a tone of the route guidance content for prompting the driver to change a traffic lane as the vehicle approaches the guidance area based on the positional information.

16. The display control device according to claim 15, wherein:
the display control unit increases the tone of the route guidance content superimposed and displayed on the road surface when a destination of guidance lane as a destination of the route guidance in the guidance area is adjacent to a traffic lane of the vehicle in a case where the route guidance is executed in the guidance area of a road including a plurality of traffic lanes; and
the display control unit reduces the tone of the route guidance content superimposed and displayed on the road surface when the destination of guidance lane is not adjacent to the traffic lane of the vehicle in a case where the route guidance is executed in the guidance area of the road including the plurality of traffic lanes.

17. A display control device for a vehicle equipped with a guidance device for executing route guidance using screen display, the display control device controlling a display of a head-up display and comprising:
a route information acquisition unit acquiring route information of the vehicle in a guidance area where route guidance is to be executed for a driver who drives the vehicle;
a positional information acquisition unit acquiring positional information of the vehicle; and
a display control unit executing the route guidance in the guidance area using a route guidance content superimposed and displayed in a foreground of the vehicle, wherein:
the display control unit terminates the route guidance of the guidance area using the route guidance content before the guidance device terminates the route guidance of the guidance area using the screen display when the vehicle passes through the guidance area without following the route guidance.

18. A display control device for a vehicle controlling a display of a head-up display, the display control device comprising:
a route information acquisition unit acquiring route information of the vehicle in a guidance area where route guidance is to be executed for a driver who drives the vehicle; and
a display control unit superimposing and displaying a route guidance content based on the route information on a road surface, wherein:
the display control unit superimposes and displays the route guidance content in the route guidance at a first branch point on a road surface of a foreground of the vehicle in a form with considering the route guidance at a second branch point to have a shape following a traffic lane change trajectory when the second branch point different from the first branch point continues to the first branch point as the guidance area.

19. The display control device according to claim 18, wherein:
the display control unit superimposes and displays the route guidance content at the first branch point in different forms between a case where a continuation distance between the first branch point and the second branch point is less than a spacing threshold value and a case where the continuation distance exceeds the spacing threshold value.

20. The display control device according to claim 18, wherein:
the display control unit superimposes and displays the route guidance content in a form corresponding to a lane change trajectory based on the route information; and
the display control unit changes the form of the route guidance content according to presence and absence of an other vehicle running behind the vehicle.

21. A non-transitory computer-readable storage medium comprising instructions being executed by a computer, the instructions including a computer-implemented method for controlling a display of a head-up display for a vehicle, the instructions causing at least one processing unit to execute:
acquiring route information of the vehicle when route guidance is executed for a driver who drives the vehicle;
superimposing and displaying an acquired route content indicating a shape of a lane change trajectory in a foreground of the vehicle based on the route information on a road surface; and
superimposing and displaying a route guidance content for executing route guidance for prompting the driver to change a traffic lane at a position deviated from the lane change trajectory in the foreground.

22. A non-transitory computer-readable storage medium comprising instructions being executed by a computer, the instructions including a computer-implemented method for controlling a display of a head-up display for a vehicle, the instructions causing at least one processing unit to execute:
acquiring route information of the vehicle in a guidance area where route guidance is to be executed for a driver who drives the vehicle;
acquiring positional information of the vehicle;
changing a control of the display on a route guidance content for route guidance for prompting the driver to change a traffic lane according to a position of a traffic lane of the vehicle indicated by the positional information when the route guidance is executed in the guidance area of a road including a plurality of traffic lanes.

23. A non-transitory computer-readable storage medium comprising instructions being executed by a computer, the instructions including a computer-implemented method for controlling a display of a head-up display for a vehicle, the instructions causing at least one processing unit to execute:
acquiring route information of the vehicle in a guidance area where route guidance is to be executed for a driver who drives the vehicle;
executing the route guidance in the guidance area using a route guidance content superimposed and displayed on a road surface;
acquiring positional information of the vehicle; and
increasing or reducing a tone of the route guidance content for prompting the driver to change a traffic lane as the vehicle approaches the guidance area based on the positional information.

24. A non-transitory computer-readable storage medium comprising instructions being executed by a computer, the instructions including a computer-implemented method for controlling a display of a head-up display for a vehicle equipped with a guidance device that executes route guidance using a screen display, the instructions causing at least one processing unit to execute:
acquiring route information of the vehicle in a guidance area where route guidance is to be execute for a driver who drives the vehicle;
executing the route guidance in the guidance area using a route guidance content superimposed and displayed in a foreground of the vehicle;
acquiring positional information of the vehicle; and
terminating the route guidance of the guidance area using the route guidance content before the guidance device terminates the route guidance of the guidance area using the screen display when the vehicle passes through the guidance area without following the route guidance.

25. A non-transitory computer-readable storage medium comprising instructions being executed by a computer, the instructions including a computer-implemented method for controlling a display of a head-up display for a vehicle, the instructions causing at least one processing unit to execute:
acquiring route information of the vehicle in a guidance area where route guidance is to be executed for a driver who drives the vehicle;
superimposing and displaying a route guidance content based on the route information on a road surface; and
superimposing and displaying the route guidance content in the route guidance at a first branch point on a road surface of a foreground of the vehicle in a form with considering the route guidance at a second branch point to have a shape following a traffic lane change trajectory when the second branch point different from the first branch point continues to the first branch point as the guidance area.

26. The display control device according to claim 1, further comprising:
one or more processors; and
a memory coupled to the one or more processors and storing program instructions that when executed by the one or more processors cause the one or more processors to provide at least: the route information acquisition unit and the display control unit.

27. The display control device according to claim 8, further comprising:
one or more processors; and
a memory coupled to the one or more processors and storing program instructions that when executed by the one or more processors cause the one or more processors to provide at least: the positional information acquisition unit, the route information acquisition unit and the display control unit.

28. The display control device according to claim 15, further comprising:
one or more processors; and
a memory coupled to the one or more processors and storing program instructions that when executed by the one or more processors cause the one or more processors to provide at least: the positional information acquisition unit, the route information acquisition unit and the display control unit.

29. The display control device according to claim 17, further comprising:
one or more processors; and
a memory coupled to the one or more processors and storing program instructions that when executed by the one or more processors cause the one or more processors to provide at least: the route information acquisition unit, the positional information acquisition unit and the display control unit.

30. The display control device according to claim 18, further comprising:
one or more processors; and
a memory coupled to the one or more processors and storing program instructions that when executed by the one or more processors cause the one or more processors to provide at least: the route information acquisition unit and the display control unit.
